(19) United States
(12) Patent Application Publication
(10) Pub. No.: US 2007/0233543 A1
(43) Pub. Date: Oct. 4, 2007

(54) INFORMATION PROCESSING APPARATUS, WORKFLOW GENERATING METHOD, AND WORKFLOW GENERATING PROGRAM

(75) Inventor: Keita Oshima, Katsushika-ku (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/688,206

(22) Filed: Mar. 19, 2007

(30) Foreign Application Priority Data
Mar. 29, 2006 (JP) 2006-091228

(51) Int. Cl. G05B 19/418

(52) U.S. Cl. 705/8

(57) ABSTRACT

When it is determined that no workflow can be generated, generating instruction information containing new workflow generation conditions is regenerated. The regenerated generating instruction information is transmitted to a processing content determination apparatus which is a transmission source of processing content information that is identified as a cause of denial in the determination. And, a workflow is generated based on processing content information re-received from the processing content determination apparatus.

### BACKGROUND OF THE INVENTION

1. Field of the Invention

The present invention relates to an information processing apparatus that generates a workflow including plural processes performed in plural systems, a method for generating the workflow, and workflow generating program.

2. Description of the Related Art

The present commercial printing industries are based on a print-ordering system including receiving, from clients, print requests for various products (e.g., magazines, newspapers, catalogs, advertisements, and gravures), producing printed products requested by the clients, and delivering the printed products to respective clients.

The commercial printing industries generally use large-scale printing apparatuses, such as offset printing machines, to perform various processes including document entry, design and/or layout, comprehensive layout (print output for presentation), correction (layout correction and color correction), proof print, camera-ready block copy production process, printing process, post-processing process, and delivery.

The camera-ready block copy production is inevitably required when the offset printing machines are used. Once a camera-ready block copy is produced, correcting the block copy is not easy and may cause a large loss. Thus, a careful proof work (i.e., check of layout and confirmation of color) is required. As described above, the conventional printing industries use large-scale apparatuses and require a long time to finish a print product requested by each client. Furthermore, each work requires expertise information (i.e., know-how of expert).

On the other hand, highly-advanced technologies of recent electrophotographic printing apparatuses and inkjet printing apparatuses can realize the print on demand (hereinafter, referred to as POD) market comparable to the printing service provided by the conventional printing industries.

The POD system is useful in processing a relatively large number of print jobs (or copies) in a short period of time without using large-scale apparatuses and systems. The POD system can utilize best performances of digital image forming apparatuses, such as digital copying machines and digital multifunction peripherals, to obtain a digital print of electronic data which cannot be realized by the above-described conventional printing system using large-scale printing machines or printing methods. According to the POD system, management and control of printing processes can be greatly digitized and computerized compared to the conventional printing system.

Furthermore, the POD system can use a workflow including plural processing processes (e. g., pre-print process, print process, and post-print process) required for outputting a print result. The printing system can execute the print processing according to the workflow and can efficiently obtain a print result requested by a client (orderer).

As discussed in Japanese Patent Application Laid-open No. 2004-164570, a workflow including the above-mentioned plural processing processes can be automatically generated to obtain a final product (i.e., output result). According to the method discussed in Japanese Patent Application Laid-open No. 2004-164570, a workflow generation apparatus stores beforehand environment information (e.g., workflow generation rules, presence of processing modules, and designation of computers that can execute respective processing modules).

The workflow generation apparatus displays, based on the environment information, selectable attribute values including the type of a recording medium to be generated as a final product (e.g., a magazine, a printed product, a print plate, a film, etc.), number of copies, size, color type, necessity of trap, and imposition method. Then, the workflow generation apparatus automatically generates a workflow based on attribute values selected by a user, pre-stored workflow generating rules, and environment information.

According to Japanese Patent Application Laid-Open No. 2004-164570, the workflow generation apparatus can display the attribute values selectable as a final product and automatically generate a workflow because the above-described environment information and the workflow generating rules are stored beforehand in the workflow generation apparatus.

However, the workflow generation apparatus discussed in Japanese Patent Application Laid-Open No. 2004-164570 may not be able to automatically generate a workflow. For example, a system executes output processing according to a workflow defining processing contents including plural processing processes performed by processing systems located at mutually remote places.

When the processing systems are located far from each other, managing the function information and restrictive information of each processing system is difficult and a workflow may not be generated according to the technique discussed in Japanese Patent Application Laid-Open No. 2004-164570.

For example, the amount of function information and restrictive information of respective processing systems positioned at plural processing locations (i.e., information corresponding to the environment information in Japanese Patent Application Laid-Open No. 2004-164570) may excessively increase. In this case, the workflow generation apparatus may not be able to store all of the environment information of all processing systems.

Furthermore, if a new device is added to a processing system of one location, complicated processing will be required to update management information for other processing systems located at different places.

From the abovementioned reasons, the workflow generation apparatus may not be able to store function information and restrictive information of all processing systems. In such a case, according to the technique disclosed in Japanese Patent Application Laid-Open No. 2004-164570, the workflow generation apparatus cannot store the environment information beforehand and accordingly cannot automatically generate a workflow.

### SUMMARY OF THE INVENTION

Exemplary embodiments of the present invention are directed to a technique capable of automatically generating a workflow including plural processing processes even in a situation that function information and restrictive information of plural processing systems cannot be managed.

According to an aspect of the present invention, an information processing apparatus can communicate with a plurality of processing content determination apparatus that determine processing content of each processing process and generate a workflow defining processing content of a plurality of processing processes. The information processing apparatus includes: a reception unit configured to receive setting information required to obtain an output result; a generation unit configured to generate generating instruction information including input format information input to the workflow or output format information output from the workflow as workflow generation conditions based on setting information received from the reception unit; a determination unit configured to transmit the generating instruction information generated by the generation unit to the plurality of processing content determination apparatus, receive processing content information including input conditions and output conditions of each processing process returned from the plurality of processing content determination apparatus, and determine whether a workflow can be generated to obtain the output result by combining the received processing content information; a regeneration unit configured to regenerate, when the determination unit determines that no workflow can be generated, generating instruction information containing new workflow generation conditions newly added to the workflow generation conditions to generate a workflow; a workflow generation unit configured to transmit the generating instruction information regenerated by the regeneration unit to a processing content determination apparatus which is a transmission source of processing content information that is identified as a cause of denial by the determination unit, and generate a workflow to obtain the output result based on determination result of re-determination processing using processing content information re-received from the processing content determination apparatus.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an exemplary arrangement of a system.

FIG. 2 is a sequence diagram illustrating an exemplary data processing flow of the system shown in FIG. 1.

FIG. 3 illustrates a fundamental arrangement of the system shown in FIG. 1.

FIG. 4 illustrates an exemplary arrangement of an end-user environment and a process management section.

FIG. 5 illustrates an exemplary arrangement of a prepress section.

FIG. 6 illustrates an exemplary arrangement of a press section.

FIG. 7 illustrates an exemplary arrangement of a postpress section.

FIG. 8 is a block diagram illustrating an exemplary circuit arrangement of a server PC.

FIG. 9 is a block diagram illustrating an exemplary circuit arrangement of a client PC.

FIG. 10 illustrates exemplary intent information having a plus effort direction value.

FIG. 11 illustrates exemplary intent information having a minus effort direction value.

FIG. 12 illustrates exemplary intent information.

FIG. 13 illustrates exemplary process information.

FIG. 14 is a block diagram illustrating an exemplary system.

FIG. 15 illustrates an exemplary intent job ticket.

FIG. 16 illustrates analysis result of an exemplary intent job ticket.

FIG. 17 illustrates an example of a prepress intermediate job ticket.

FIG. 18 illustrates an example of a press intermediate job ticket.

FIG. 19 illustrates an example of a postpress intermediate job ticket.

FIG. 20 illustrates an exemplary process job ticket.

FIG. 21 illustrates exemplary information stored in a database of a prepress server.

FIG. 22 illustrates exemplary information stored in a database of a press server.

FIG. 23 illustrates exemplary information stored in a database of a postpress server.

FIG. 24 illustrates an exemplary method for converting an intermediate job ticket to process information.

FIG. 25 illustrates an exemplary conversion into process information.

FIG. 26 illustrates an exemplary storage state of a process job ticket.

FIG. 27 illustrates an exemplary re-conversion into process information.

FIG. 28 illustrates an exemplary storage state of a re-converted process job ticket.

FIG. 29 illustrates exemplary pattern for changing designation of input/output conditions.

FIG. 30 illustrates exemplary conversion into process information.

FIG. 31 illustrates an exemplary storage state of a process job ticket.

FIG. 32 illustrates an exemplary intent condition loosening method.

FIG. 33 illustrates an exemplary prepress process job ticket.

FIG. 34 illustrates an exemplary press process job ticket.

FIG. 35 illustrates an exemplary postpress process job ticket.

FIG. 36 illustrates an exemplary workflow job ticket.

FIG. 37 is a flowchart illustrating exemplary processing performed in an information processing apparatus.

FIG. 38 is a flowchart illustrating exemplary processing performed in an information processing apparatus.

FIG. 39 is a flowchart illustrating exemplary processing performed in an information processing apparatus.

FIG. 40 is a block diagram illustrating an exemplary system.

FIG. 41 illustrates exemplary intent condition loosening method according to a third exemplary embodiment.

FIG. 42 illustrates exemplary information associating intent information to processing process.

FIG. 43 illustrates exemplary processing for generating process information.

### DETAILED DESCRIPTION OF THE EMBODIMENTS

The following description of exemplary embodiments is merely illustrative in nature and is in no way intended to limit the invention, its application, or uses.

It is noted that throughout the specification, similar reference numerals and letters refer to similar items in the following figures, and thus once an item is defined in one figure, it may not be discussed for following figures.

Exemplary embodiments will be described in detail below with reference to the drawings.

### First Exemplary Embodiment

### [Schematic Arrangement of System]

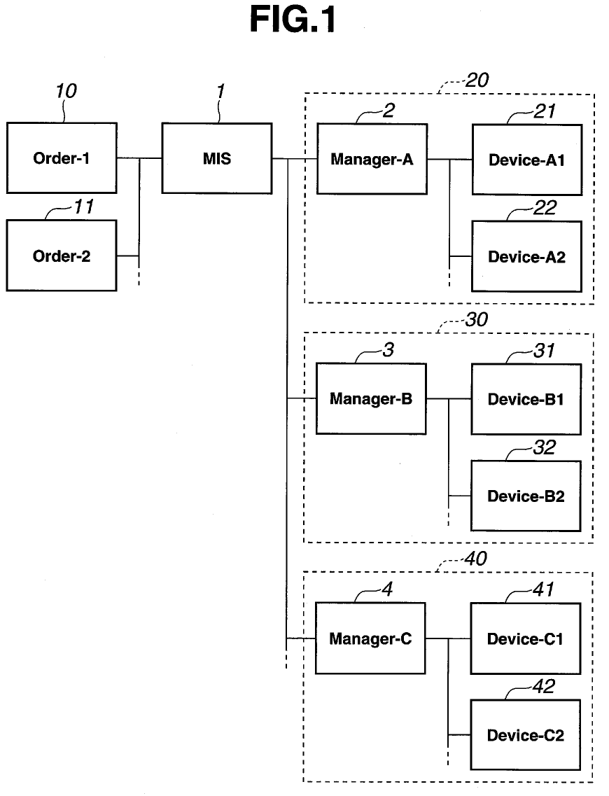

FIG. 1 is a block diagram illustrating an exemplary system arrangement. The system shown in FIG. 1 includes a portion that places a job request (an order), a portion that receives the job request, and a portion that actually processes the received job request.

In FIG. 1, a management information system (MIS) 1 can generate a workflow for processing a received job request. MIS 1 analyzes a received job request, determines a workflow defining the order of required processes, and requests an optimum system to execute processing for the received job request. FIG. 1 illustrates plural systems 20, 30, and 40 which are connected to MIS 1. MIS 1 can request a manager (2˜4) of each system to execute the processing. The order sections 10 and 11, connected to MIS 1, generate job request information and transmit the job request information to MIS 1.

In addition to the order sections 10 and 11, other order sections can be connected to MIS 1. Each of the order sections 10 and 11 can serve as a client apparatus (i.e., a host computer). The managers 2 through 4 are connected to MIS 1. Each of the systems 20 through 40 can execute output processing (e.g., print bookbinding processing) according to an instruction of MIS 1. In addition to the managers 2 through 4, other managers can be added to the system shown in FIG. 1. Each manager can communicate with devices belonging to the same system.

For example, the manager 2 is connected to devices 21 and 22 belonging to a process group 20. When an instruction relating to a job request is transmitted from MIS 1, the manager 2 controls the devices 21 and 22 to generate an output result according to a workflow generated by MIS 1. Similarly, the manager 3 is connected to devices 31 and 32 belonging to a process group 30. The manager 4 is connected to devices 41 and 42 belonging to a process group 40. The order section 10 or 11 can transmit intent information (i.e., data reflecting client's intent) to MIS 1.

MIS 1 generates a workflow defining the processing order of processes executed in each system to obtain an output result based on the intent information. Therefore, MIS 1 transmits instruction information (i.e., information required to generate processing content of an assigned process) to the manager of each system. Each manager determines processing content to be executed in the own system according to the instruction information received from MIS 1. MIS 1 determines a workflow as a combination of information collected from respective managers. Each manager executes processing according to the workflow determined by MIS 1 to obtain an output result corresponding to the job request.

### [Processing Sequence of System]

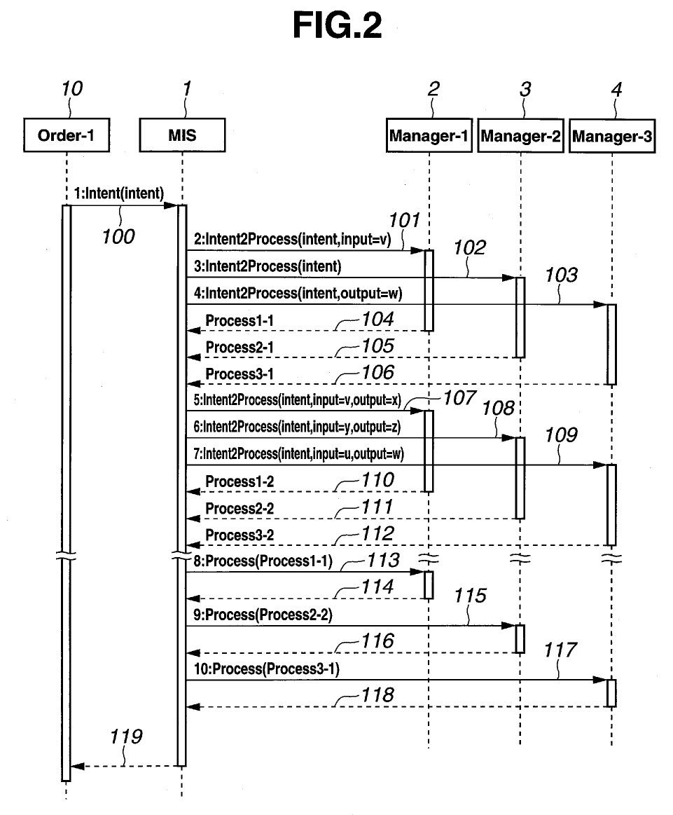

FIG. 2 illustrates an exemplary sequence of a data processing flow of the system according to the present embodiment. In FIG. 2, blocks having the same functions as those shown in FIG. 1 are denoted by the same reference numbers. First, the order section 10 transmits intent information to MIS 1 (refer to 100). MIS 1 transmits intermediate job tickets 101 through 103 to the managers 2 through 4 of respective systems based on the intent information. The intermediate job ticket contains predetermined information relating to restrictive conditions. For example, restrictive conditions shown in FIG. 2 include “Input=v” sent to the manager 2 (refer to 101) and “Output=w” sent to the manager 4 (refer to 103).

The intermediate job ticket is information notified to the manager of each process to determine processing content of a workflow, which can be expressed as “processing content generating instruction information(generating instruction information)” in the following description. The restrictive condition information contained in an intermediate job ticket is information based on the intent information. The intent information can be expressed as “workflow generation conditions” in the following description.

Each manager, in each system, selects a device that executes processing described in an intermediate job ticket received from MIS 1 and returns a process job ticket to MIS 1 (refer to 104 through 106). MIS 1 generates a workflow based on process job tickets returned from respective managers and transmits the workflow to each manager.

MIS 1 transmits a generated workflow, as a workflow job ticket, to each manager. Each manager executes processing of the own system according to the received workflow job ticket. If MIS 1 determines that no workflow can be generated based on the received process job tickets, MIS 1 repeatedly collects process job tickets. In this case, MIS 1 retransmits intermediate job tickets including modified contents to respective managers 2 through 4 (refer to 107 through 109). Respective managers return process job tickets according to the newly received intermediate job tickets (refer to 110 through 112).

MIS 1 and the managers 2 through 4 repeatedly execute transmission/reception of information as indicated by 101 through 106 or 107 through 112. As a result, the MIS analyzes collected process job tickets and determines a workflow corresponding to the intent information received from the order section 10. Then, MIS 1 transmits workflow job ticket to the manager of each system. According to the flow shown in FIG. 2, MIS 1 transmit regenerated intermediate job tickets to the managers of all systems. However, MIS 1 can selectively retransmit an intermediate job ticket to only the manager that fails to return an effective process job ticket to generate a workflow.

According to the flow shown in FIG. 2, the manager 2 executes processing according to a workflow job ticket “Process 1-1” (refer to 113), and transmits processing completion (refer to 114). Both of the manager 3 and the manager 4 execute similar processing (refer to 115 through 118). If MIS 1 determines that all processing has completed, MIS 1 transmits a final product to the order section 10 (refer to 119). In FIG. 2, MIS 1 successively transmits workflow job tickets to respective managers. Alternatively, MIS 1 can simultaneously transmit a common workflow job ticket (i.e., a job ticket describing processing content of all processes) to each manager. The manager (server) of each processing process can be expressed as a “processing content determination apparatus” that determines the processing content contained in a workflow.

### [System Arrangement]

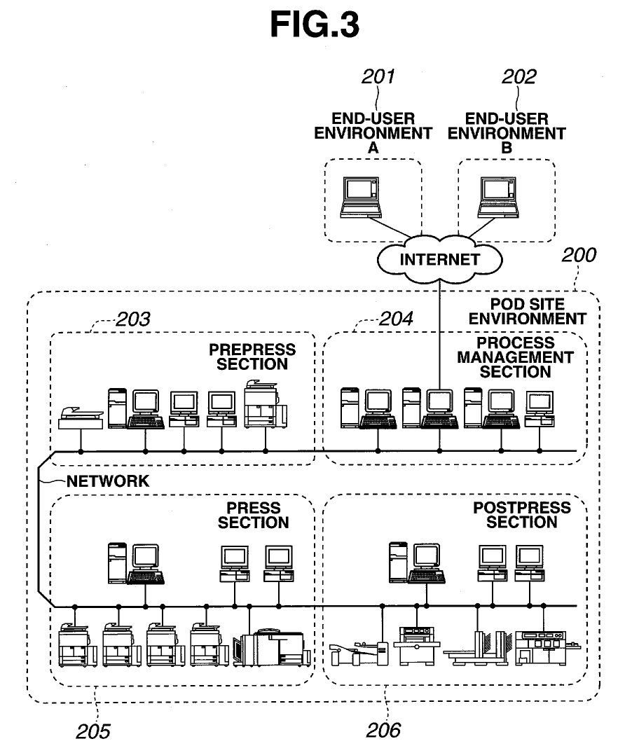

FIG. 3 illustrates an exemplary arrangement of a system to which embodiment of the present invention can be applied. The system includes one (or plural) end-user environment and a print on demand (POD) site environment 200 connected via the Internet. At least one client (orderer) who makes a print order request is present in the end-user environment (end-user environment A 201 and end-user environment B 202).

Each client (orderer), operating a client PC, can request a print job or confirm the status of each job from the end-user environment. The POD site environment 200 includes a prepress section 203, a press section 205, a postpress section 206 (i.e., a total of three process groups) and a process management section 204. The process management section 204 can instruct works in respective processes of the prepress section 203, the press section 205, and the postpress section 206 in the POD site environment 200.

In other words, the process management section 204 can realize integrated management of workflows in the system including computers and various devices. The process management section 204 can receive print bookbinding orders from the end-user and store the received orders. Furthermore, the process management section 204 can assemble two or more individual work processes as a workflow based on the designation of the job requests received from each end-user, and can efficiently schedule the work processes for individual devices or workers.

FIG. 3 illustrates two end-user environments 201 and 202 corresponding to the order sections 10 and 11 and MIS 1 shown in FIG. 1. Furthermore, the prepress section 203, the press section 205, and the postpress section 206 correspond to the process groups (20, 30, 40, etc) shown in FIG. 1. The process management section 204 includes MIS as described below.

### [System Arrangement of Process Management Section]

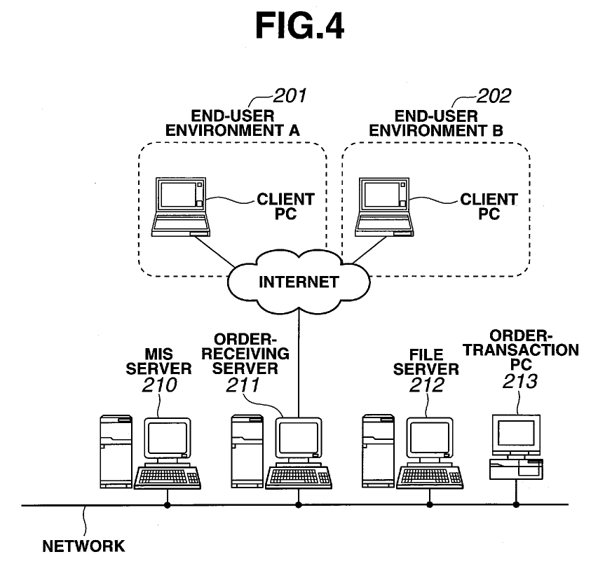

FIG. 4 illustrates an exemplary arrangement of the end-user environments 201 and 202 and the process management section 204 (see FIG. 3). The process management section 204 includes a MIS server 210, an order-receiving server 211, a file server 212, and an order-transaction PC 213 connected to a network.

The MIS server 210 can manage various workflows, including from reception of an order to delivery of a product, in the system and can manage various administrative information and sales information. The order-receiving server 211 can receive a job request from the end-user environment via the Internet and can manage a received job as intent information. The MIS server 210 receives intent information from the order-receiving server 211 and transmits the intent information together with image data to succeeding processes according to an instruction of the MIS server 210.

The file server 212 stores a job received from an end-user so as to be prepared for a reordering of the same document. In general, the file server 212 can store image data together with setting information (job ticket) used in the previous job. The order-transaction PC 213 is a terminal located at a counter of a print shop. Similar to the order-receiving server 211, the order-transaction PC 213 can transmit intent information to the MIS server 210 when a user comes to a print shop to place an order.

The MIS server 210 shown in FIG. 4 corresponds to MIS 1 shown in FIG. 1. The MIS server 210, the order-receiving server 211, and the order-transaction PC 213 in the process management section 204 can exchange information using a job ticket describing work instructions of a job which can be referred to as job definition format (JDF). Using the job ticket, the process management section 204 can transfer a job and issue a control command, to cooperate with the prepress section 203, the press section 205, and the postpress section 206 to realize a totally automated workflow.

### [System Arrangement of Prepress Section]

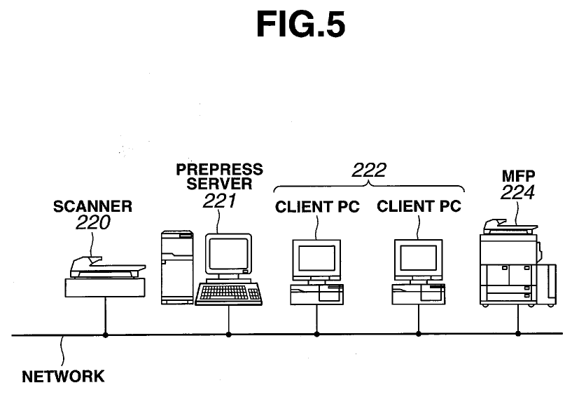

FIG. 5 illustrates an exemplary arrangement of the prepress section 203 (see FIG. 3). The prepress section 203 includes a scan device, such as a scanner 220 and a scan device equipped in a multifunction peripheral (MFP) 224, which can capture an image of a paper document received from an end-user as a scan image file.

Furthermore, the prepress section 203 includes at least one client PC 222 that can execute image correction including correction of obliqueness and various processing including merge, page layout/edit, and imposition of document/image files received from end-users and image files scanned by a scan device. Furthermore, the prepress section 203 includes a prepress server 221 that performs allocation of job to a worker and the client PC 222 according to a job instruction received from the MIS server 210.

When a copy job is received from an end-user, a worker operates the scan device (e.g., scanner/MFP) to capture an image of a paper document. Then, the prepress server or the client PC inputs a scan image file. When the scan image is inclined, the client PC performs processing for correcting the obliqueness of the scan image. Furthermore, when the scan image includes punch holes or spoiled portions, the client PC performs processing for removing black points (i.e., images of punch holes and spoiled portion).

When a print job is received from an end-user, a worker controls the prepress server or the client PC to input a document/image file received from the end-user. If plural document/image files are received from end-users, or when plural scan image files are obtained by the scan device, the prepress section can combine these files.

Furthermore, when editing a received document/image file or a scan image file is required, a worker can operate the prepress server or the client PC to insert additional page(s) to or delete page(s) from an edit object file while confirming the layout of plural pages. Furthermore, the prepress section can execute various page layout/edit and imposition processing, including addition of page numbers and annotations, designation of N-up print or successive-page print (printing plural pages on a single print surface), insertion of index and cover and interleaf slips, and designation of post-processing (e.g., stapling, and punching).

The prepress section 203 stores various application software installed to execute prepress processing. An operable client PC, a connectable scan device, and a processible data type are dependent on the type of application software. There are plural workers who can execute the prepress processing. Usable application software and a client PC are variable depending on each worker (i.e., depending on the degree of skill).

The prepress server 221 selects an appropriate client PC with application software and an appropriate worker to allocate a job. The prepress section 203 is connected to the process management section 204 via a network. The MIS server 210 does not perform direct communications with the prepress section 203, a scan device, or a client PC for exchange of information. Instead, the MIS server 210 can select an appropriate system (e.g., a worker, a client PC, and application software) via the prepress server 221 and can transmit a job instruction via the prepress server 221.

### [System Arrangement of Press Section]

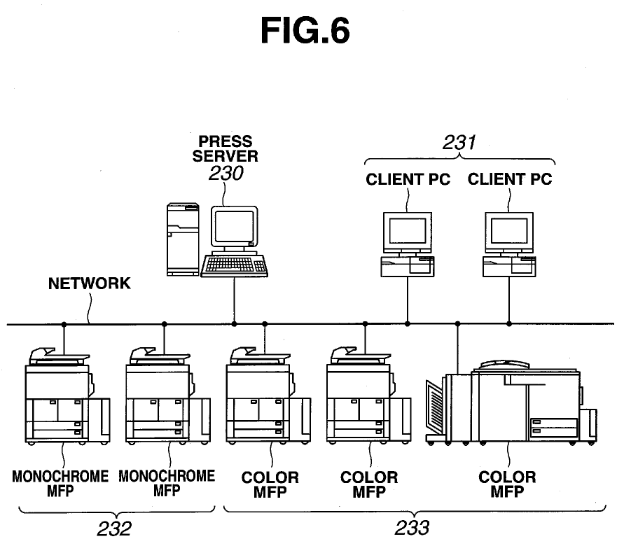

FIG. 6 illustrates an exemplary arrangement of the press section 205 (see FIG. 3). The press section 205 includes a press server 230, two client PCs 231, three color MFPs 233, and two monochrome MFPs 232 which are connected to a network. The press server 230 performs allocation of job to each color MFP 233 or to each monochrome MFP 232 according to a job instruction received from the MIS server 210. If necessary, the press server 230 can transmit an instruction to a press section worker via the client PC 231 to allocate a job to the worker.

Similar to the prepress section 203, the press section 205 allocates a job to an appropriate device or to an appropriate worker. Although the press section 205 is connected to the process management section 204 via a network, the MIS server 210 does not directly transmit or receive information to or from the devices or client PCs in the press section 205. The MIS server 210 selects an appropriate device via the press server 230 and outputs a job instruction to the selected device via the press server 230.

### [System Arrangement of Postpress Section]

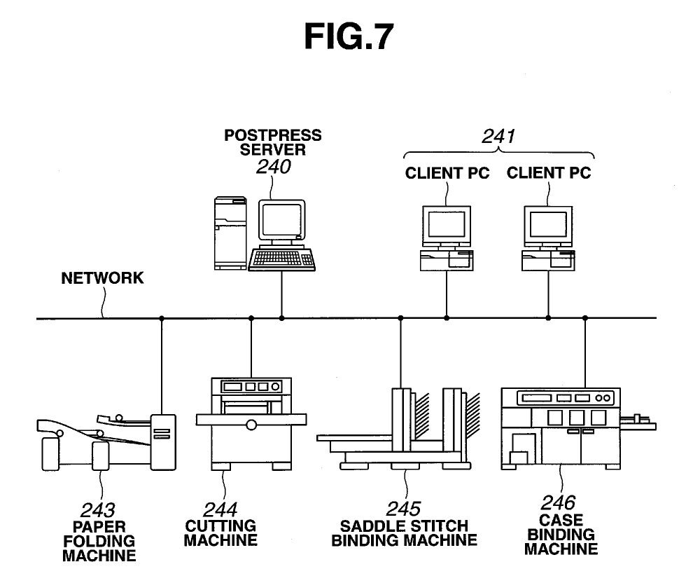

FIG. 7 illustrates an exemplary arrangement of the postpress section 206 (see FIG. 3). The postpress section 206 includes a postpress server 240, two client PCs 241, and post-processing devices including a paper folding machine 243, a cutting machine 244, a saddle stitch binding machine 245, a case binding machine 246 which are connected to a network.

The postpress server 240 is a computer capable of controlling and managing post-processing processes. The postpress server 240 can select a post-processing apparatus that can perform finishing processing in the postpress section based on job instruction transmitted from the MIS server 210. Then, a selected post-processing device executes post-processing (finishing processing) processes to obtain an output result requested by an end-user.

The post-processing devices can be roughly classified into three categories (i.e., in-line finishers, near-line finishers, and off-line finishers) which are defined in the following manner, although the near-line finisher and the off-line finisher are chiefly described below.

### (In-line Finisher)

In-line finishers are post-processing devices physically connected to MFPs and can directly receive printed sheets produced from the MFPs via paper paths (conveyance paths) Furthermore, the in-line finishers are electrically connected to the MFPs and can receive operational instructions and status confirmation from the MFPs.

### (Near-line Finisher)

Near-line finishers are post-processing devices not physically connected to MFPs via paper paths. Workers (operators) of respective near-line finishers are required to manually convey and place (or set) output products. However, the near-line finishers are electrically connected to the MFPs and can transmit and receive information (e.g., operational instructions and status confirmation), via a network or communication medium, to and from the MFPs.

### (Off-line Finisher)

Off-line finishers are post-processing devices not physically connected to MFPs via paper paths and not electrically connected to the MFPs for transmission/reception of operational instructions and status confirmation. Workers of respective off-line finishers are required to manually convey and place (or set) output products, manually input operation information and data, and confirm the status reported from the devices.

Furthermore, the post-processing devices can execute sheet processing processes applied to recording sheets printed by MFPs or other image forming apparatuses to finish the recording sheets into a bookbinding product requested by each end-user.

The post-processing devices execute various sheet processing, including cutting process, saddle stitch bookbinding process, case binding process, paper folding process, punching process, insertion process, collation process, applied to recording sheets (papers) printed by MFPs or other image forming apparatus.

The postpress server can manage various near-line finishers and, if necessary, can manage off-line finishers. For example, the postpress server can manage a stapler, a punching machine, a mail inserter and a collator in addition to the paper folding machine 243, the cutting machine 244, the saddle stitch binding machine 245, and the case binding machine 246 shown in FIG. 7.

The postpress server can monitor the device status and the job status of each near-line finisher by performing successive polling according to a predetermined protocol and can manage the execution status of each job.

In the present exemplary embodiment, the above-described plural sheet processing processes can be performed by an integrated system including plural processing devices or can be performed by a single processing apparatus. Furthermore, the system of the present exemplary embodiment can be arranged so as to include some devices in an integrated processing system.

The system of the present embodiment may include some of sheet processing apparatus selected from plural sheet processing apparatus. When the job contents include a manual work by a worker, the postpress server 240 transmits information to the client PC 241 to perform management.

Similar to the prepress section 203 and the press section 205, the postpress section 206 is connected via a network to the process management section 204. The MIS server 210 does not directly transmit or receive information to or from the devices or client PCs in the postpress section 206. The MIS server 210 selects an appropriate device and a worker via the post press server 240 and transmits a job instruction to the selected device or worker via the postpress server 240.

### [Arrangement of Server PC]

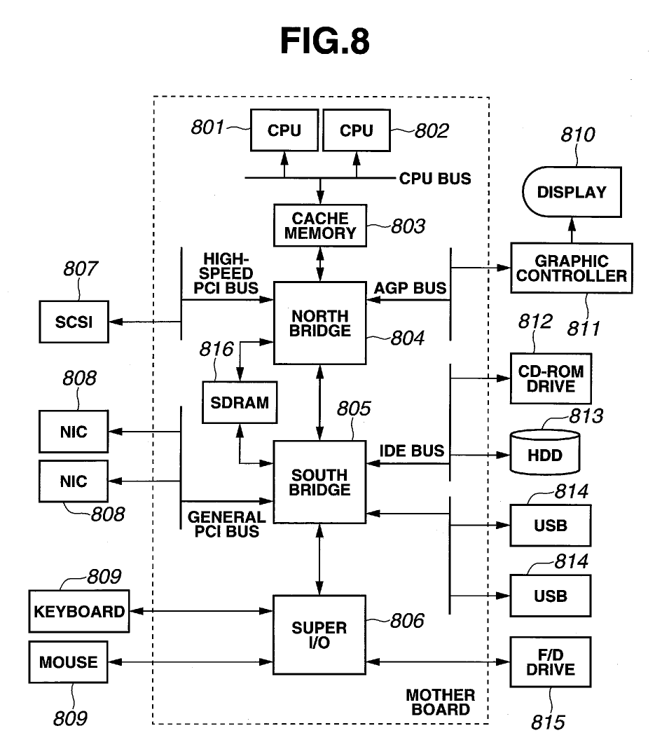

FIG. 8 illustrates an exemplary arrangement of an information processing apparatus, e.g., the MIS server 210, prepress server 221 (see FIG. 5), press server 230 (see FIG. 6), and postpress server 240 (see FIG. 7), used in the present invention. A portion surrounded by a dotted line is a mother board on which the following functional components are mounted. CPU 801 and CPU 802, each controlling the software of the information processing apparatus, are connected via a CPU bus to a cache memory 803.

Furthermore, CPU 801 and CPU 802 can perform various bus controls for the mother board via a north bridge 804 and a south bridge 805 which are large scale integration (LSI) chips. An SDRAM 816, or other comparable memory, can store temporary data exchanged between the north bridge 804 and the south bridge 805 or other data processed in the information processing apparatus.

The north bridge 804 has a high-speed peripheral component interconnect (PCI) bus which is for example a 32 bit/66 MHz type or can be a high-speed PCI Express or a PCI-X. The north bridge 804 can access an external SCSI device 807 (e.g., a hard disk drive or other mass storage device such) via a SCSI controller and a SCSI interface. Furthermore, the north bridge 804 is connected to a graphic controller 811 via an AGP bus. The graphic controller 811 controls display of a display unit 810.

The south bridge 805 is connected, via a general PCI bus (32 bit/33 MHz), to each network interface card (NIC) 808, such as an Ethernet. FIG. 2 illustrates two cards 808 respectively used for different types of networks. However, if only one network is used, only one NIC 808 can be provided.

The south bridge 805 is connected, via an integrated disk electronics (IDE) bus, to a hard disk drive (HDD) 813 and a CD-ROM drive (or CD-R drive) 812. The hard disk drive (HDD) 813 stores control software of the information processing apparatus and various data. The CD-ROM drive 812 can read data from a portable medium and record data to a portable medium.

The south bridge 805 can access, via a USB port, to USB memories 814 or other external USB device. The information processing apparatus is connected, via a super I/O section 806, to input devices 809, such as a keyboard and a mouse, or to a floppy disk drive (F/D drive) 815 for the input/output of data.

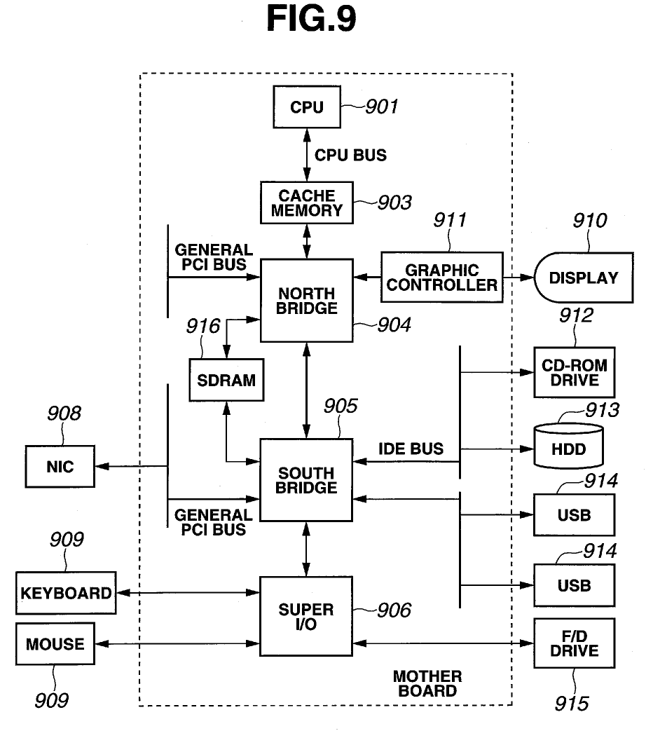

FIG. 9 illustrates an exemplary arrangement of each client PC that includes various blocks similar to those shown in FIG. 8. A portion surrounded by a dotted line is a mother board on which the following functional components are mounted. CPU 901 controls the software of the information processing apparatus, and connected via a CPU bus to a cache memory 903.

Furthermore, CPU 901 can perform various bus controls for the mother board via a north bridge 904 and a south bridge 905 which are large scale integration (LSI) chips. An SDRAM 916, or other comparable memory, can store temporary data exchanged between the north bridge 904 and the south bridge 905 or other data processed in the information processing apparatus.

The north bridge 904 has a high-speed peripheral component interconnect (PCI) bus which is for example a 32 bit/66 MHz type or can be a high-speed PCI Express or a PCI-X. Furthermore, the north bridge 904 is connected to a graphic controller 911 via an AGP bus. The graphic controller 911 controls display of a display unit 910.

The south bridge 905 is connected, via a general PCI bus (32 bit/33 MHz), to each network interface card (NIC) 908, such as an Ethernet. The south bridge 905 is connected, via an integrated disk electronics (IDE) bus, to a hard disk drive (HDD) 913 and a CD-ROM drive (or CD-R drive) 912. The hard disk drive (HDD) 913 stores control software of the information processing apparatus and various data. The CD-ROM drive 912 can read data from a portable medium and record data to a portable medium.

The south bridge 905 can access, via a USB port, to USB memories 914 or other external USB device. The information processing apparatus is connected, via a super I/O section 906, to input devices 909, such as a keyboard and a mouse 909, or to a floppy disk drive (F/D drive) 915 for the input/output of data.

### [Intent information and Process Information]

Servers can exchange intent job tickets and process job tickets. For example, print bookbinding contents include user's desire roughly classified into two types of information. The intent job ticket can be defined as setting information for obtaining an output result. In the present embodiment, the process job ticket contains processing content of each process. In this respect, the process job ticket can be defined as “processing content information.”

First type of user's desire is information reflecting user's desire. In the present embodiment, this type of information (i.e., the data describing user's request) is referred to as “intent job ticket.”

Second type of user's desire is information relating to a processing unit or a processing procedure that can realize user's desire. In this case, data such as “how a request is satisfied?” may be described. In the present embodiment, this type of information is referred to as “process job ticket.” Intent job tickets and process job tickets are roughly classified into two types.

An intent job ticket and a process job ticket may have the same information amount. For example, a user may “desire A4-size bookbinding” in the designation of sheet size. An intent job ticket if including such user's desire corresponds to an instruction “feed A4-size sheets” supplied to a print device or an instruction “cut sheets into A4 size” supplied to a cutting device. In this case, although the sheet size may be differently expressed (e.g., A4 or 210 mm×297 mm), the description contents of an intent job ticket can be directly used for a process job ticket.

Furthermore, an intent job ticket can express processing result using predetermined range information. For example, when a user desires “bookbinding in a range from A6-size to A4-size”, a size satisfying the processing procedure conditions can be selected from plural options. A process job ticket, if selecting A5-size as one of the options, corresponds to an intent job ticket.

As described above, an intent job ticket can be unequivocally related to a process job ticket regardless of device or worker. For example, a relationship that A5-size is larger than A6-size and smaller than A4-size is always established regardless of device. In the present embodiment, the above-mentioned relationship between an intent job ticket and a process job ticket is referred to as “absolute correspondence.”

On the other hand, an intent job ticket may include job request information designating “as - - - as possible” which is dependent on the timing of an order or the state of an order destination (e.g., the type of a usable device or a worker). For example, an instruction may be a designation, such as “as high image quality as possible”, “cost-oriented”, or “delivery time-oriented.”

For example, when an instruction includes “cost-oriented” designation, the cost required to obtain similar processing result may be different depending on each print store or company. Such a correspondence between an intent job ticket and a process job ticket is referred to as “relative correspondence” in the present embodiment.

### [Method for Expressing Intent Job Ticket having Relative Correspondence]

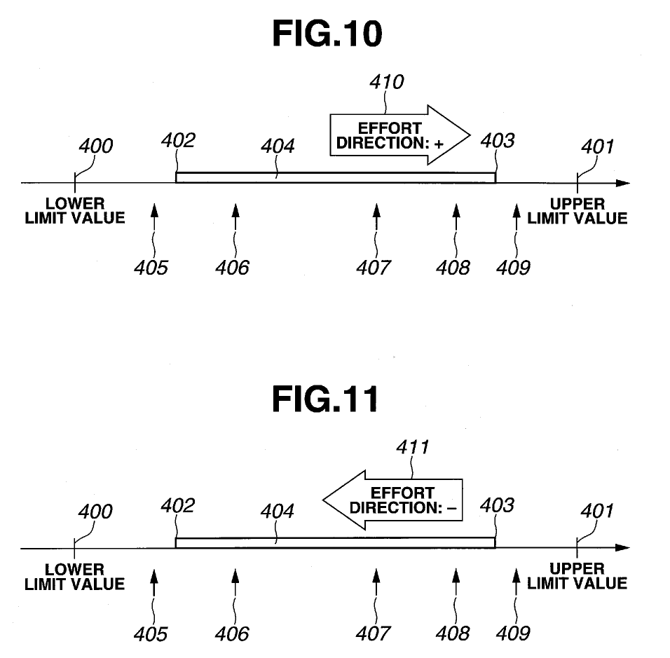

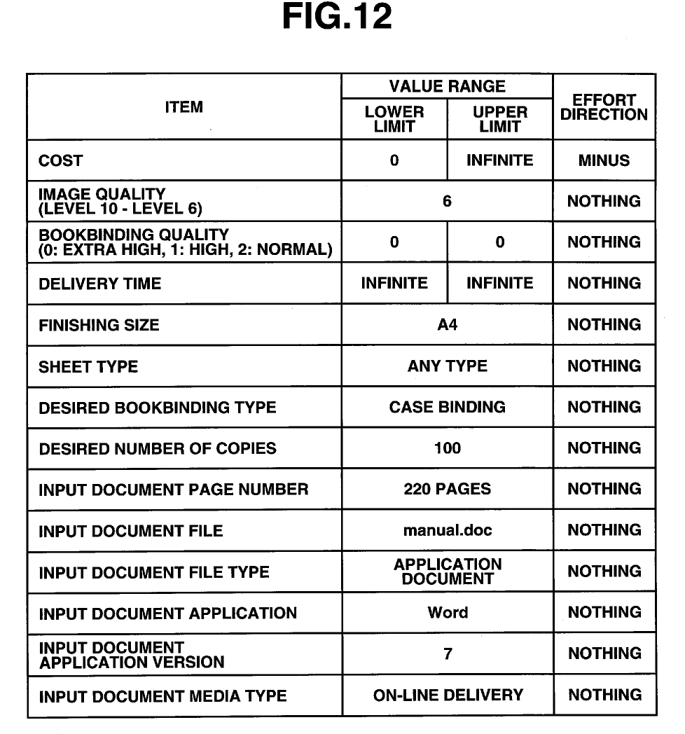

FIGS. 10 and 11 illustrate exemplary method for expressing process information and intent information having relative correspondence according to the present embodiment. In the present embodiment, intent information is a one-dimensional variable having an upper limit value and a lower limit value. Or, intent information has discrete setting values. As described above, discrete setting values are unequivocally correlated to process information.

Therefore, discrete setting values are intent information having absolute correspondence to process information. Character strings, such as document names, are not selectable setting values. However, character strings can be directly correlated to process information. Therefore, character strings are intent information having absolute correspondence to process information.

When intent information is a variable having upper/lower limit values, the information includes an additional “effort direction value.” The effort direction value is a factor that determines optimum process information when plural process information values have correspondence to intent information defined by upper/lower limit values. The effort direction value can be any one of three options, “+(plus)”, “−(minus)”, and “no effort direction.”

FIG. 10 illustrates exemplary intent information having a plus effort direction value. The intent information shown in FIG. 10 includes upper/lower limit values defined on a numerical line with an arrow representing a positive (plus) direction. FIG. 10 shows a lower limit value 400 and an upper limit value 401 of process information. The intent information shown in FIG. 10 is defined by a value range 404, a lower limit value 402, and an upper limit value 403. Furthermore, the intent information includes a plus effort direction value 410. The intent information 404 and 410 indicate that a user desires setting a value as large as possible in the range defined by the lower limit value 402 and the upper limit value 403.

Furthermore, FIG. 10 shows option values 405 through 409 of the process information. According to the example shown in FIG. 10, option value 405 is lower than the lower limit value 402 of the intent information and option value 409 is larger than the upper limit value 403 of the intent information. Thus, both of the option values 405 and 409 are out of the intent information designation range 404. On the other hand, option values 406 through 408 are within the intent information designation range 404. As the effort direction value 410 has a “plus” value, the largest value is selected among the option values 406 through 408. Accordingly, in the example shown in FIG. 10, the option value 408 is optimum process information corresponding to the intent information defined by the value range 404 and the effort direction value 410.

An example corresponding to FIG. 10 is designation of image quality. For example, the image quality can be selected among level 1 through level 10. If a user desires the highest image quality in a range from level 4 (corresponding to 402) to level 8 (corresponding 403), the level 7 (corresponding to 408) is an image quality level corresponding to the intent information (i.e., optimum process information satisfying user's desire).

FIG. 11 illustrates exemplary intent information having a minus effort direction value. Same reference numerals are denoted to conditions similar to those shown in FIG. 10. According to the example shown in FIG. 11, option value 406 is optimum process information corresponding to the intent information defined by the value range 404 and an effort direction value 411.

The schedule of a print job is an example corresponding to FIG. 11. For example, a lower limit value 400 of the process information is reception date/time of intent information. An upper limit value 401 of the process information is the latest due date that a print store or company can schedule. A user desires finishing a print job as early as possible in an allowable date/time range.

A user can designate upper/lower limit values of an intent information designation range irrespective of upper/lower limit values of the process information. Thus, intent information designation range may exceed a range defined by upper/lower limit values of the process information. For example, upper/lower limit values of intent information can be designated to infinite values. For example, if a user desires finishing a print job as early as possible without designating any due date, intent information may include infinite upper/lower limit values and a minus effort direction value.

### [Exemplary Intent Information]

FIG. 12 illustrates exemplary intent information based on the above-mentioned expression. The table shown in FIG. 12 includes items of intent information (in a first column from the left), a value or a value range of intent information (in a second column), and an effort direction value (in a third column). When intent information has only one value without having the value range in the second column, upper/lower limit values are equal to this value.

If an intent information item has an effort direction value “nothing” in the third column, the intent information item absolutely corresponds to the process information. If an intent information item has an effort direction value other than “nothing”, the intent information item relatively corresponds to the process information.

According to the example shown in FIG. 12, the effort direction value of “cost” is “minus.” Accordingly, only the “cost” is an item relatively corresponding to the process information.

### [Exemplary Process Information]

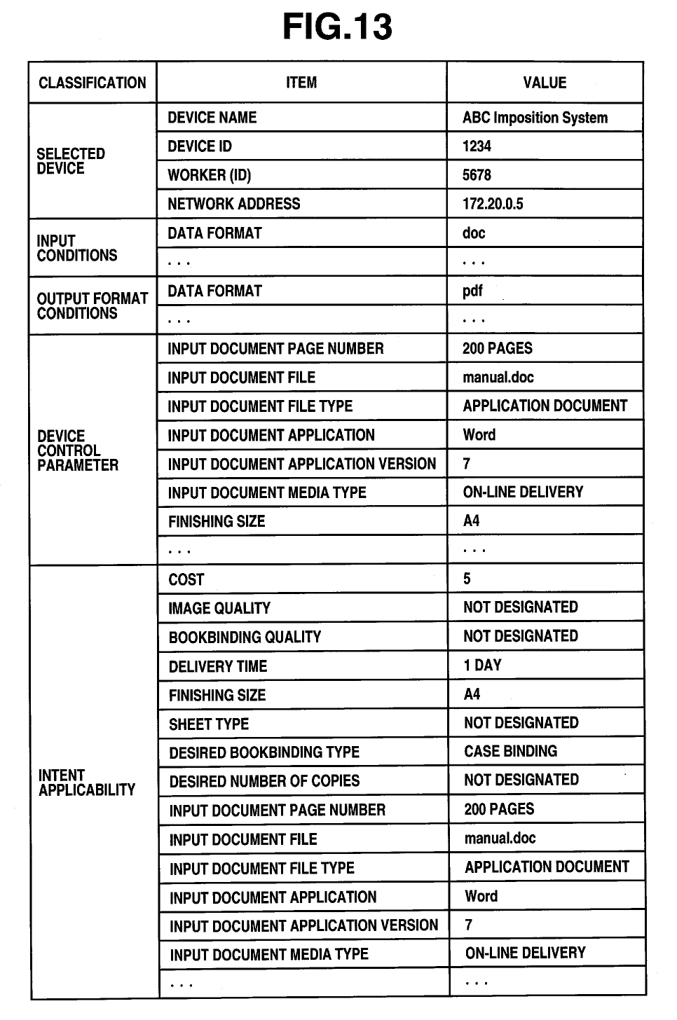

FIG. 13 illustrates exemplary process information. The process information can be determined by a server (a manager) of each process based on intent information. According to the present embodiment, the prepress server 221, the press server 230, and the postpress server 240 are exemplary process servers. FIG. 13 illustrates exemplary process information determined by the prepress server 221. The process information shown in FIG. 13 includes numerous items classified into five categories, i.e., selected device, input conditions, output format conditions, device control parameters, and intent applicability.

The “selected device” is information relating to a device that can be used to satisfy intent information in a system managed by a manager. For example, as shown in FIG. 13, the selected device information is application software executing prepress processing or a worker handling the device.

The “input conditions” are conditions of input information for a selected device. The type of input conditions is different depending on the type of system or the type of device. The process information determined by the prepress server includes an item “data format” as “input conditions” as shown in FIG. 13. The “data format” is a data format of a prepress processing object. According to the example shown in FIG. 13, the data format “doc type” is designated as “input conditions.”

The “output format conditions” are information representing a format of an output resulting from processing of a selected device. The type of “output format conditions” is different depending on the type of a system or the type of a device. As shown in FIG. 13, an item “data format” is designated as the “output format conditions” for the prepress server. The “data format” represents a format of data output by the prepress processing. According to the example shown in FIG. 13, a data format “pdf type” is designated as “output conditions.”

The “device control parameters” include a list of instruction information for a selected device, which are required for each device to execute processing. The information items described in the “input conditions” and the “output format conditions” may be similar to information items described in the “device control parameters.” For example, a data format “doc type” designated in the “input conditions” is a doc type of an input document file described in the “device control parameters” in FIG. 13. The “input conditions” and the “output format conditions” are required to confirm the connectivity of a later-described workflow and are designated separately from the “device control parameters.”

The “intent applicability” represents the “applicability” of generated process information to the intent information. More specifically, the “intent applicability” shows a comparison between each intent information item and the content of selected process information. The “intent applicability” may include the information similar to the “device control parameters,” although the “intent applicability” includes values corresponding to intent information items.

### [Functional Block Arrangement of Server]

Next, the processing performed in the MIS and each manager will be described. In addition to the above-mentioned problems, the present embodiment intends to solve the following problems.

If the workflow generating apparatus cannot store function information and restrictive information of all processing systems, a workflow may be automatically generable by inquiring of each processing system about the capability of realizing the contents of each processing process.

However, to produce a workflow defining plural processing processes, properly connecting (combining) respective processing processes is required. However, determination of a first processing process will be repeatedly performed if no processing system can accept an output format of the first processing process. Thus, the efficiency deteriorates.

If function information and restrictive information of plural processing systems cannot be managed, the conventional techniques cannot efficiently generate a workflow. The present embodiment intends to efficiently generate a workflow considering the above problems.

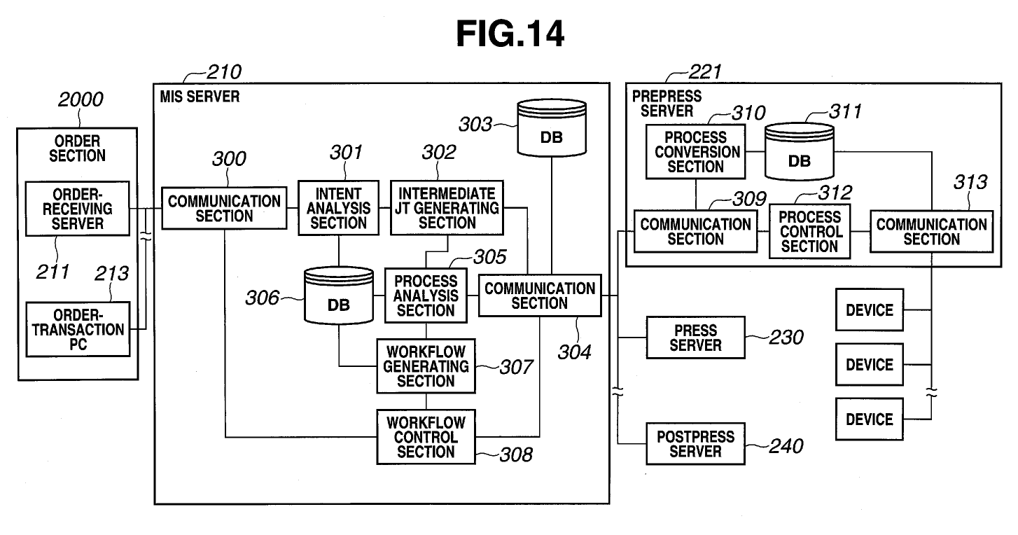

FIG. 14 illustrates an exemplary system arrangement including an order section 2000, an MIS server 210, a prepress server 221, a press server 230, and a postpress server 240. Each of the press server 230 and the postpress server 240 has functional blocks similar to those of the prepress server 221, although not shown in detail in the drawing.

The prepress server 221 includes two communication sections 309 and 313, a process conversion section 310, a database 311, and a process control section 312. The MIS 210 includes a communication section 300 capable of controlling communications between the MIS server 210 and an order section 2000 (including an order-receiving server 211 and an order-transaction PC 213). The communication section 300 of the MIS server 210 can receive intent information from the order section 2000. The intent information has a file format referred to as an intent job ticket (intent JT). The communication section 300 can transmit the received intent job ticket to an intent analysis section 301 and can send a notice to the order section 2000 when the processing of an order-received job is completed.

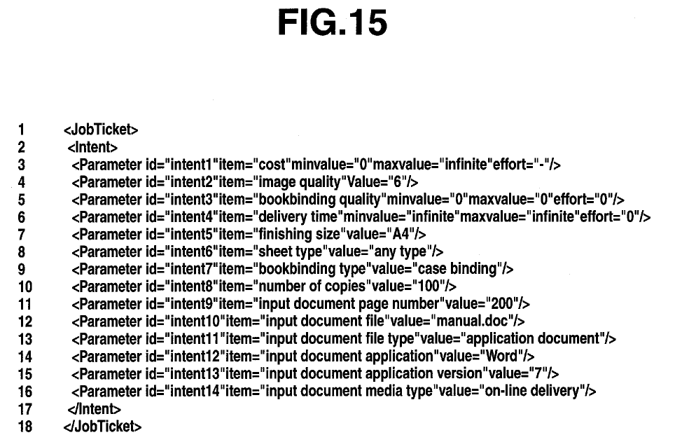

The intent analysis section 301 can determine processing processes required to output a requested result based on the intent job ticket received from the communication section 300. The processing performed in the intent analysis section 301 will be described later with reference to FIGS. 15, 16, and 42. A database 306 stores information relating to the processing processes determined by the intent analysis section 301. An intent job ticket and related information stored in the database 306 can be transmitted to an intermediate JT generating section 302.

The intermediate JT generating section 302 can associate a required processing process with the type of a manager that can process each processing process (e.g., a prepress server for a prepress process). Then, the intermediate JT generating section 302 generates an intermediate job ticket for each manager and sends a request via a communication section 304 to each of the prepress server 221, the press server 230, and the postpress server 240 to generate process information.

The communication section 304 can check a manager executing each processing process analyzed by the intent analysis section 301 with reference to the information stored in the database 303. The database 303 stores correspondence information relating to a processing process and a manager, such as a prepress processing process and a prepress server. Accordingly, the communication section 304 can transmit an intermediate job ticket to a manager that determines processing content of processing processes determined by the intent analysis section 301.

When each manager receives a process information generation instruction from the communication section 304, each manager generates process information based on the received intermediate job ticket. The communication section 304 receives process information having a file format referred to as “process job ticket” and stores the received process information in the database 303.

For example, in the prepress server 221, the communication section 309 receives an intermediate JT and sends the intermediate JT to the process conversion section 310. The process conversion section 310 can convert an intermediate job ticket into process information with reference to the information stored in the database 311. The converted process information is returned via the communication section 309 to the MIS server 210. The press server 230 and the postpress server 240 can execute similar processing.

The process analysis section 305 receives a process job ticket from each manager and stores the received ticket in the database (DB) 306. Furthermore, the process analysis section 305 determines whether a workflow can be generated by combining process job tickets stored in the DB 306 to process an order received from the order section 2000. If the process analysis section 305 determines that no workflow can be generated, collecting additional process job tickets is further required.

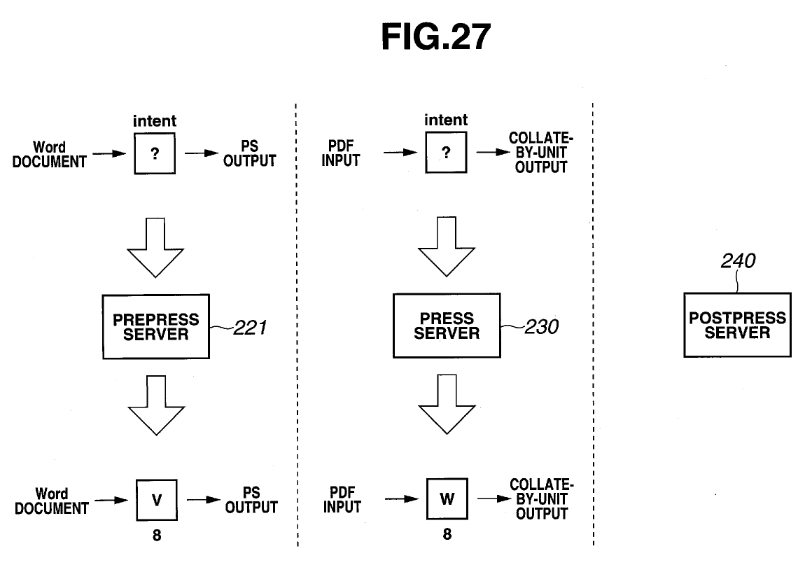

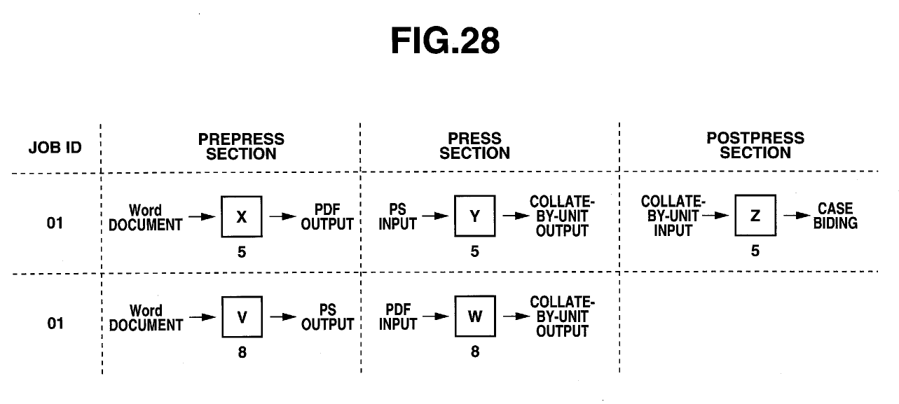

Therefore, the process analysis section 305 requests the intermediate JT generating section 302 to generate an intermediate job ticket. The generated intermediate job ticket is again transmitted to a manager. The job ticket regenerated by the intermediate JT generating section 302 contains new restrictive conditions (new workflow generation conditions) described in FIGS. 27 and 28.

Then, if the process analysis section 305 determines that a workflow for processing a received order can be generated based on re-collected process job tickets, the process analysis section 305 sends a completion notice to the workflow generating section 307. The workflow generating section 307 produces an optimum workflow by combining process job tickets stored in the database 306. Then, the workflow generating section 307 transmits workflow job tickets arranging a generated workflow to the workflow control section 308.

The workflow control section 308 transmits an instruction to each manager via the communication section 304 according to the generated workflow job tickets. For example, in the case of bookbinding processing, the workflow generating section 307 generates an optimum workflow for the bookbinding processing. The workflow control section 308 transmits processing content of each process arranging the generated workflow to each manager.

For example, the prepress server 211 receives information containing processing content (job) relating to the prepress processing. The process control section 312 controls a device via the communication section 313 to process the job. The press server 230 and the postpress server 240 perform similarly. After the processing of all processes is completed, the workflow control section 308 sends a job completion notice to the order section 2000 via the communication section 300.

As described above, the MIS server of the present invention can communicate with plural managers that determine processing content of each processing process and can generate a workflow defining processing content of plural processing processes.

### [Intent Job Ticket]

FIG. 15 illustrates an exemplary intent job ticket received by the communication section 300 from the order section 2000 shown in FIG. 14. The intent job ticket shown in FIG. 15 includes contents corresponding to the intent information shown in FIG. 12. The job ticket according to the exemplary embodiment has a text document format using markup language (e.g., SGML or XML), although the present embodiment uses a simplified expression. The intent job ticket shown in FIG. 15 includes information consisting of a total of eighteenth rows.

The intent job ticket shown in FIG. 15 includes “<JobTicket>” representing start of job ticket description (i.e., first row) and “</JobTicket>” representing termination of job ticket description (i.e., eighteenth row). If a keyword is defined in the present embodiment, description relating to keyword contents begins at a row including the keyword in parentheses “<” and “>” and ends at a row including the same keyword in parentheses “</” and “>”. The description relating to “<JobTicket>” includes “<Intent>” consisting of third to sixteenth rows describing contents of intent information. The description relating to intent information contains at least one description relating to the “item”, “value range”, and “effort direction” shown in FIG. 12.

A format shown in FIG. 15 includes “<Parameter” indicating start of description, “id”, “item”, “minvalue”, “maxvalue”, “value”, “effort” showing exemplary values, and “/>” indicating end of description. More specifically, the value “id” indicates a unique value identifying a description relating to an intent job ticket. For example, an “id” value of the third row is “Intent1.”

Furthermore, the value “item” indicates a name corresponding to an item shown in FIG. 12. For example, an “item” value of the third row is “cost.” Namely, the third row of FIG. 15 corresponds to the item “cost” shown in FIG. 12. The value “minvalue” corresponds to the lower limit value shown in FIG. 12. For example, a “minvalue” value of the third row is “0.” Moreover, “maxvalue” corresponds to the upper limit value shown in FIG. 12. For example, a “maxvalue” value of the third row is “infinite.”

The value “value” corresponds to a value having no range in FIG. 12. For example, a “value” value of the fourth row is “6.” Furthermore, the value “effort” corresponds to the effort direction shown in FIG. 12. A minus “effort” value is indicated by “−”, a plus “effort” value is indicated by “+”, and no “effort” value is indicated by “0.” For example, an “effort” value of the third row is “minus (−).”

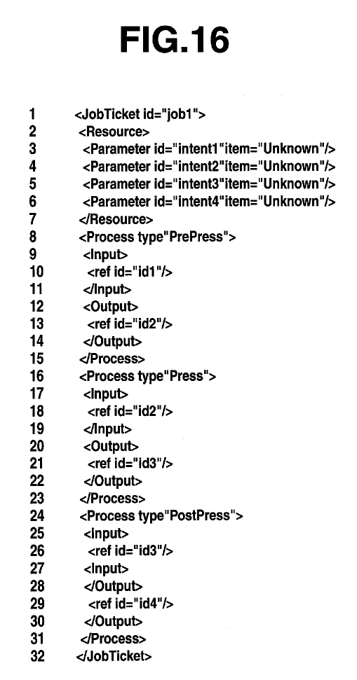

FIG. 16 illustrates a job ticket obtained by the intent analysis section 301 shown in FIG. 14 that has analyzed the intent job ticket shown in FIG. 15. The job ticket shown in FIG. 16 is a basis of a later-described intermediate job ticket and transmitted together with the intent job ticket shown in FIG. 15 from the intent analysis section 301 to the intermediate JT generating section 302.

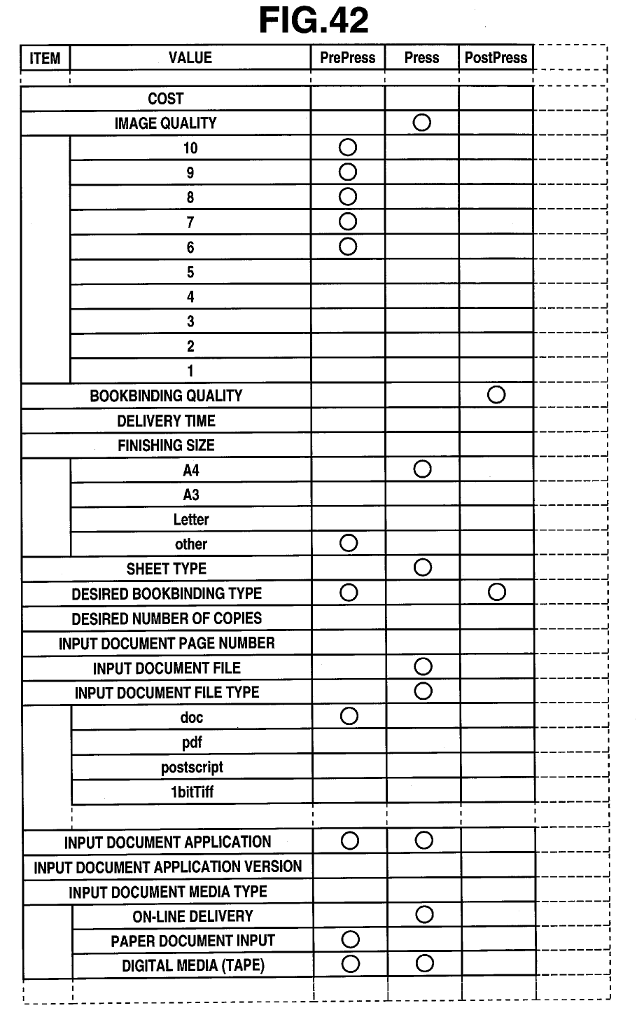

The MIS server stores information shown in FIG. 42 that includes intent information and associated processing process. The process analysis section 305 determines required processing processes based on received intent information and the information stored in FIG. 42.

According to the example shown in FIG. 16, the process analysis section 305 analyzes that three processes (prepress, press, and postpress) are required. The job ticket shown in FIG. 16 includes description relating to “<JobTicket>” which contains description relating to “<Resource>” and description relating to “<Process>.” The first row starting with “<JobTicket” includes an identifier that indicates update history of the job ticket. According to the example shown in FIG. 16, “JobTicket id=job1” is an identifier of the job.

Third through sixth rows are description relating to “<Resource>” which represents input/output conditions of the prepress, the press, and the postpress. The third row starting with “<Parameter” describes a resource. A value indicated by “id” is a unique value identifying description relating to a resource. A value indicated by “item” represents the type (item) of the resource. However, the intent analysis section 301 cannot determine input/output conditions of each processing process based on only the information described in the intent job ticket shown in FIG. 15. Thus, a value “Unknown” is described.

The description of fourth through sixth rows is similar to the above-described description of the third row, and therefore, it will not be repeated here.

Eighth through fifteenth rows are description relating to the prepress. A “type” value in the eighth row indicates the prepress. The description relating to “<Process>”, ranging from eighth to fifteenth rows, includes description relating to “<Input>” and “<Output>” describing input and output information of the prepress. The tenth row is “refid=id1” representing input conditions of the prepress processing corresponding to the contents described in the third row including “id1.” The thirteenth row is “refid=id2” representing output conditions of the prepress processing corresponding to the contents described in the fourth row including “id2.”

Similarly, input conditions of the press processing correspond to the contents described in the fourth row including “id2” and output conditions of the press processing correspond to the contents described in the fifth row including “id3.”

Furthermore, input conditions of the postpress processing correspond to the contents described in the fifth row including “id3” and output conditions of the postpress processing correspond to the contents described in the sixth row including “id4.”

As the “item” value of each input/output resource is “Unknown”, conditions are not determined yet. However, the job ticket shown in FIG. 16 indicates that a workflow can be formed by connecting input conditions and output conditions which refer to the same “id” value. More specifically, the prepress inputs something (id=1) and produces an output (id=2). The press inputs the output (id=2) of the prepress and produces an output (id=3). The postpress inputs the output (id=3) of the press and produces an output (id=4).

The intent analysis section 301 can refer to an exemplary standard shown in FIG. 42 to determine whether the job ticket FIG. 16 can be generated based on the intent job ticket shown in FIG. 15. The information shown in FIG. 42 can be stored beforehand in the database 306. In FIG. 42, two columns from the left (i.e., “item” and “value”) describe each item involved in the intent job ticket and its value(s). The third through fifth columns represent respective processes (i.e., “PrePress”, “Press”, and “PostPress”).

A round mark put to an item or value, if the item or value is contained in an intent job ticket, indicates that a corresponding process is required. For example, if an intent job ticket includes an item “image quality”, a round mark is put to the “Press.” Accordingly, the intent analysis section 301 can determine that a press process is required to process a received intent job ticket. Furthermore, if the image quality is designated by a numerical level equal to 6 through 10, a round mark is put to the “PrePress.” Hence, the intent analysis section 301 can determine that a prepress process is also required.

Although FIG. 42 shows only the portions relating to the examples shown in FIGS. 15 and 16, all information required to specify processes based on the description contents of the intent job ticket can be described.

The intent analysis section 301 can specify processes required for processing an intent job ticket based on the table information shown in FIG. 42. In this case, the processing order of processes can be determined beforehand with reference to the type of each process. It is needless to say that prepress processes precede press processes and postpress processes. Although FIG. 42 shows only three types of processes, any other type of processes can be added.

Furthermore, if the table shown in FIG. 42 is not available, the database 306 can store information instructing that three processing processes (i.e., prepress process, press process, and postpress process) are required to obtain a bookbinding product. The intent analysis section 301, if an intent job ticket includes an instruction that an orderer requests a bookbinding product, can determine required processing processes based on the information stored in the database 306 and the received intent job ticket. In this case, a combination of required processing processes is dependent on the contents of the intent job ticket.

### [Intermediate Job Ticket]

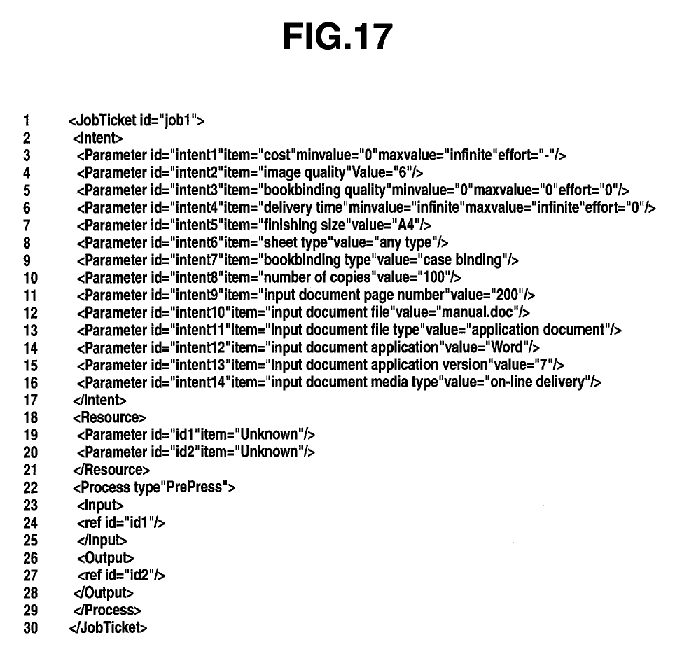

The intermediate JT generating section 302 generates an intermediate job ticket based on the intent job ticket shown in FIG. 15 and the job ticket shown in FIG. 16 to send an inquiry to each process server. In the present embodiment, the intermediate JT generating section 302 generates three intermediate job tickets shown in FIGS. 17, 18, and 19 based on the description contents of FIG. 16 which require prepress, press, and postpress processing.

First, the intermediate JT generating section 302 makes a copy of the intent job ticket shown in FIG. 15. Then, the intermediate JT generating section 302 selects description relating to “<Resource>” and “<Process>” corresponding to each process from the job ticket shown in FIG. 16. And, the intermediate JT generating section 302 copies the selected description into the “<JobTicket>” description in the copied intent job ticket.

For example, when an intermediate job ticket transmitted to the prepress server is generated, the intermediate JT generating section 302 copies the eighth through fifteenth rows shown in FIG. 16 (corresponding to the twenty-second through twenty-ninth rows in FIG. 17). Furthermore, the intermediate JT generating section 302 copies the second through fourth rows and the seventh row of FIG. 16 which correspond to “id1” and “id2” referred to in the eighth through fifteenth rows of FIG. 16 (corresponding to the eighteenth through twenty-first rows shown in FIG. 17).

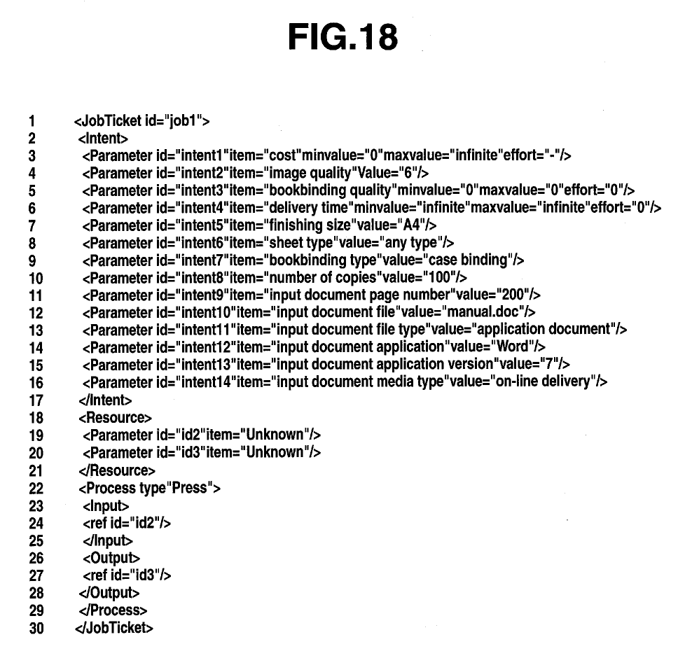

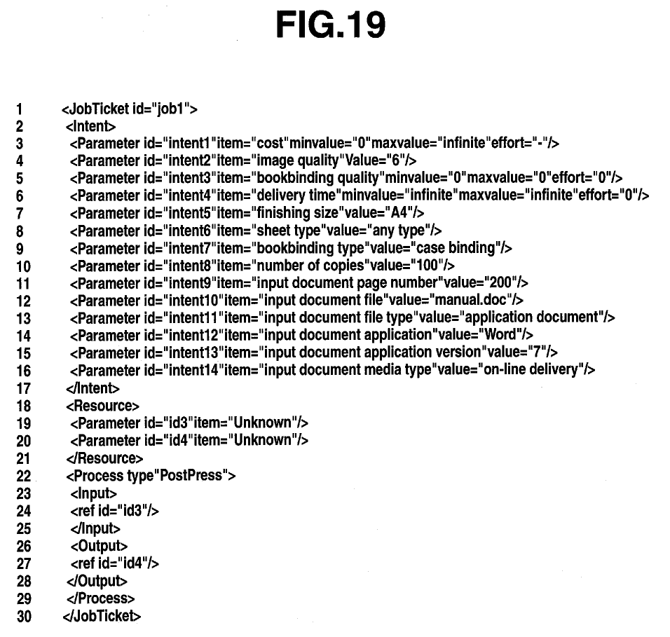

Then, the intermediate JT generating section 302 puts an identifier (“job1”) to the first row of FIG. 17 which is identical to the identifier of the job ticket shown in FIG. 16. By executing the above-mentioned processing, the intermediate job ticket shown in FIG. 17 can be generated for prepress server. The intermediate JT generating section 302 executes the similar processing for each of the press server and the postpress server and generates intermediate job tickets shown in FIGS. 18 and 19.

Each manager (each process server) can convert an intermediate job ticket into a process job ticket. The intermediate job tickets shown in FIGS. 17 through 19 are similar in the description ranging from third through sixteenth rows, although the description is not limited to the example.

For example, the intermediate JT generating section 302 can extract information required for each process from an intent job ticket and can generate an intermediate job ticket. For example, the intermediate JT generating section 302 can generate an intermediate job ticket for a bookbinding processing process which includes no intent information relating to the image quality because the bookbinding processing requires no settings relevant to the image quality.

The intermediate JT generating section 302, based on received setting information, generates an intermediate job ticket including, as workflow generation conditions, input format information (e.g., “.doc”) to be input to a workflow or output format information (e.g., “case binding”) to be output from the workflow.

### [Process Job Ticket]

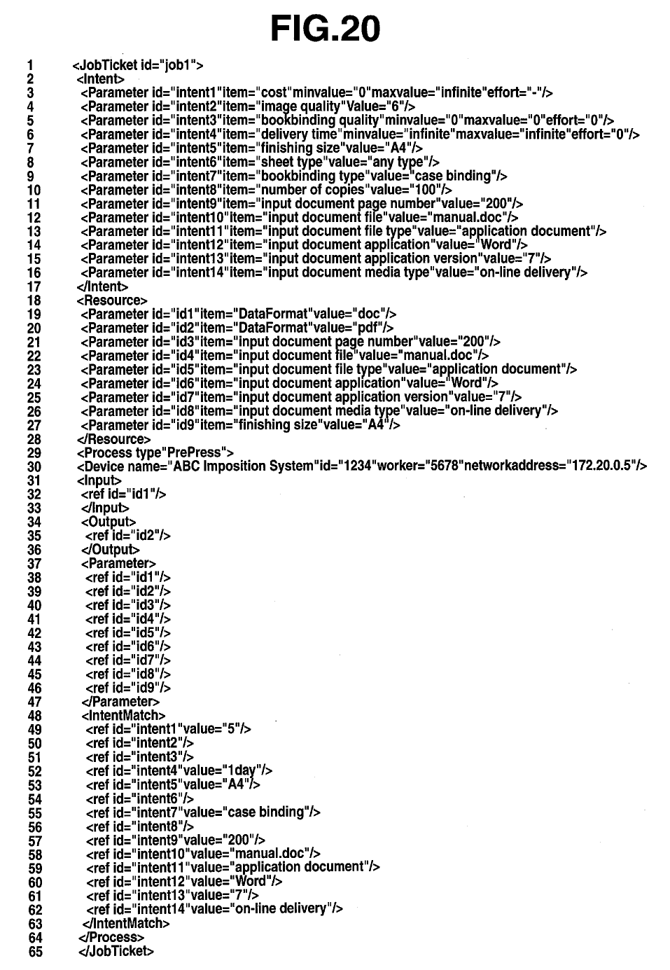

FIG. 20 illustrates an exemplary process job ticket generated by the prepress server 221 based on process information obtained from the intermediate job ticket shown in FIG. 17. The process job ticket shown in FIG. 20 includes contents corresponding to the process information shown in FIG. 13. Only the differences between FIG. 20 and FIG. 17 are described below.

First, the thirtieth row is description relating to “<Device/>.” The description of the thirtieth row is information for specifying a device and a worker which the prepress server 221 has selected based on the intermediate job ticket shown in FIG. 17 received from the MIS. The “Device name” value is a device name.

As the job ticket shown in FIG. 20 is used for the prepress processing, the “Device name” is a name identifying a processing system or software rather than a name of an apparatus. Thus, the thirtieth row of FIG. 20 describes “ABC Imposition System” as a system name. In the exemplary job ticket, “id” represents an identifier that identifies an individual device. When plural devices are the same type, the identifier “id” can be used to unequivocally specify the devices. Furthermore, “worker” is an identifier that specifies a worker. Even if a process (e.g., press process) is automated, a manual work by a worker is required, for example, for moving printed sheets or supplementing running stores. However, when a job (i.e., a process) is executable without specifying a worker, the “worker” value can be omitted.

Moreover, “network address” specifies an address of a network connected to a device. As described above, a device performing the processing and a worker can be specified in the thirtieth row. The description relating to “<Device/>” corresponds to the classification of selected device shown in FIG. 13. Furthermore, the job ticket shown in FIG. 20 includes exemplary “<Parameter>” data in the description relating to “<Resource>” ranging from eighteenth to twenty-eighth rows.

At the moment an intermediate job ticket is transmitted to each manager, the MIS server 210 cannot determine what kind of instruction (parameters) can be designated to a device managed by each manager. Therefore, the exemplary intermediate job tickets for respective processes shown in FIGS. 17 through 19 involve “<Resource>” information which is “unknown.”

Each manager receives an intermediate JT from the MIS, and determines a device that can process the contents described in the received intermediate JT. Furthermore, each manager instructs processing content (parameters) to the determined device. Exemplary parameters in the “<Resource>” description are input/output conditions of each process (device). In the description relating to the “<Resource>” ranging from eighteenth to twenty-eighth rows shown in FIG. 20, “item” represents the type of a designated parameter and “value” shows a designated parameter value. These parameters are referred to as process input/output or device parameters and are accompanied by an identifier “id” being a unique value.

The job ticket shown in FIG. 20 includes description relating to “<Input>” ranging from thirty-first through thirty-third rows and “<Output>” ranging from thirty-fourth through thirty-sixth rows. Both “<Input>” and “<Output>” are updated so as to refer to appropriate “<Parameter>” according to detailed description relating to “<Resource>.” The description relating to “<Input>” corresponds to the classification of input conditions shown in FIG. 13. The description relating to “<Output>” corresponds to the classification of output format conditions shown in FIG. 13.

Thirty-seventh through forty-seventh rows of the job ticket shown in FIG. 20 are description relating to “<Parameter>” which does not include exemplary parameter values. The “<Parameter>” description refers to the “<Parameter>” described in the “<Resource>.” A description format for the “<Parameter>” is similar to the format for the “<Input>” and “<Output>.” The description relating to the “<Parameter>” corresponds to the classification of the device control parameters shown in FIG. 13.

Forty-eighth through sixty-third rows of the job ticket shown in FIG. 20 are description relating to “<IntentMatch>.” The “<IntentMatch>” description includes “<ref---/>” description that indicates a relationship between each item involved in the process job ticket shown in FIG. 20 and an applied item in the intent job ticket based on the intent job ticket shown in FIG. 16.

For example, the forty-ninth row of FIG. 20 shows a relationship that “Intent1” value=“5”. This means that the cost value is 5, for the “cost” described in the third row of FIG. 20 which has the same identifier (Intnet1). The above-mentioned description is related to each process group. For example, the cost is information requiring the entire evaluation. Even in such a case, the process job ticket shown in FIG. 20 includes a result determined by only the prepress server 221. Furthermore, an item not relating to a processing process includes no exemplary value “value” that is similar to “nothing” in the intent applicability shown in FIG. 13. The description relating to “<IntentMatch>” corresponds to the classification of intent applicability shown in FIG. 13.

### [Process Information Generating Processing]

Next, a process information generating procedure is described. The process conversion section 310 shown in FIG. 14 receives an intermediate job ticket from the MIS server 210 and converts the received intermediate job ticket into process information based on the information stored in the database 311.

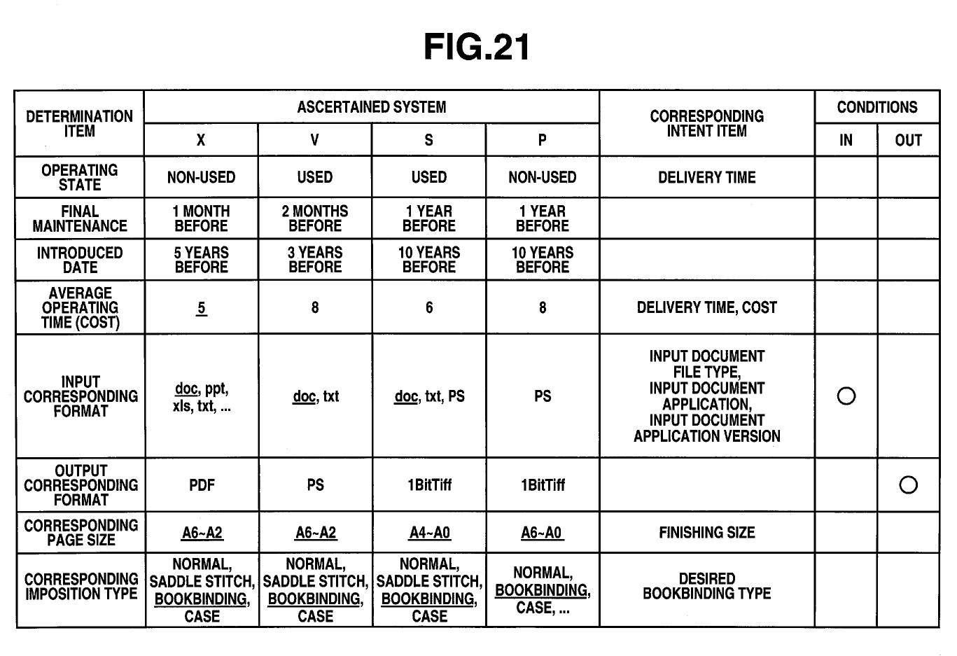

FIGS. 21 through 23 illustrate exemplary information stored in each database for process information conversion processing performed in the prepress server 221, the press server 230, and the postpress server 240. In FIGS. 21 through 23, the column indicated by “determination item” shows the standards according to which each manager can select a device from the contents described in an intermediate job ticket. The “determination item” includes items corresponding to input conditions and output conditions of each process.

In FIG. 21, the column indicated by “ascertained system” shows a list of ascertained systems managed by the manager and exemplary values corresponding to determination items in each system. For example, according to the example shown in FIG. 21, four systems X, V, S, and P are managed and ascertained by the prepress server 221. The column indicated by “corresponding intent item” shows intent information items corresponding to determination items. For example, the prepress server 221 can determine information relating to the delivery time of intent information by confirming a determination item “operation status.”

The column identified by “input conditions” shows a round mark designating a “determination item” which serves as an object of the input conditions of the process. The column identified by “output conditions” shows a round mark designating a “determination item” which serves as an object of the output format conditions of the process.

### [Workflow Generating Processing]

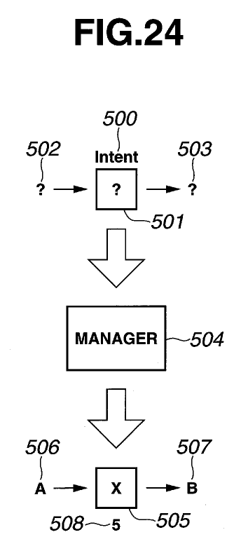

The prepress server 221, the press server 230, and the postpress server 240 can generate process information based on the information described in FIGS. 21 through 23 and the intermediate job tickets shown in FIGS. 17 through 19. Then, the MIS server 210 describes the procedure for generating a workflow based on the process information generated by respective managers. FIG. 24 illustrates a method for converting an intermediate job ticket into process information.

In FIG. 24, the intermediate JT generating section 302 shown in FIG. 14 generates intermediate job ticket information 500 through 503. Intent information 500 corresponds to the contents described in the second through seventeenth rows of FIG. 17.

Information 501 represents a device selected by each manager. The intermediate JT generating section 302 cannot determine the device(s) of each process based on only the information described in the intent information. Thus, the information 501 of the intermediate job ticket describes “?” as a selected device.

Information 502 is input conditions corresponding to the description contents of twenty-third through twenty-fifth rows of FIG. 17 and the nineteenth row which is referred to by the twenty-third through twenty-fifth rows of FIG. 17. For example, when the input conditions are undetermined (described “Unknown” in the nineteenth row) as shown in FIG. 17, the information 502 describes “?” as input conditions.

Information 503 is output format conditions corresponding to the description contents of twenty-sixth through twenty-eighth rows of FIG. 17 and the twentieth row which is referred to by the twenty-sixth through twenty-eighth rows of FIG. 17. For example, when the output format conditions are undetermined (described “Unknown” in the twentieth row) as shown in FIG. 17, the information 503 describes “?” as output format conditions.

Information 504 is a manager. According to the example shown in FIG. 24, the information 504 describes the prepress server. Information 505 through 508 is part of process information converted by the prepress server.

The prepress server determines a device 505 that executes the processing described in the intermediate job ticket shown in FIG. 17 based on the intermediate job ticket shown in FIG. 17 and the information shown in FIG. 21.

As shown in FIG. 21, the systems X, V, S, and P are ascertained by the prepress server. The received intermediate job ticket shown in FIG. 17 contains the intent information shown in FIG. 12, which describes a request that the cost is as low as possible. Therefore, the prepress server 504 selects a system that can perform the process at the lowest cost among ascertained systems. A determined device corresponds to description contents in the thirtieth row of FIG. 20.

Information 506 indicates input conditions of the system 505 corresponding to the contents described in thirty-first through thirty-third rows shown in FIG. 20 and the nineteenth row which is referred to by the thirty-first through thirty-third rows. The information 506 describes input conditions determined based on the input corresponding format of a selected system and input-related items of the intent information.

Information 507 indicates output format conditions corresponding to the contents described in thirty-fourth through thirty-sixth rows shown in FIG. 20 and the twentieth row which is referred to by the thirty-fourth through thirty-sixth rows. The information 507 describes output format conditions determined in the same manner as the information 506 (input conditions).

Information 508 indicates intent applicability corresponding to the contents described in forty-eighth through sixty-third rows shown in FIG. 20. In the following description, only an intent information item serving as an object that narrows a desired range of the intent is described. In the present embodiment, the intent information item (i.e., information 508) is a “cost” value.

FIGS. 21 through 23 illustrate exemplary information of a limited number of devices and determination items. However, similar processing can be realized even if more information is stored in the database.

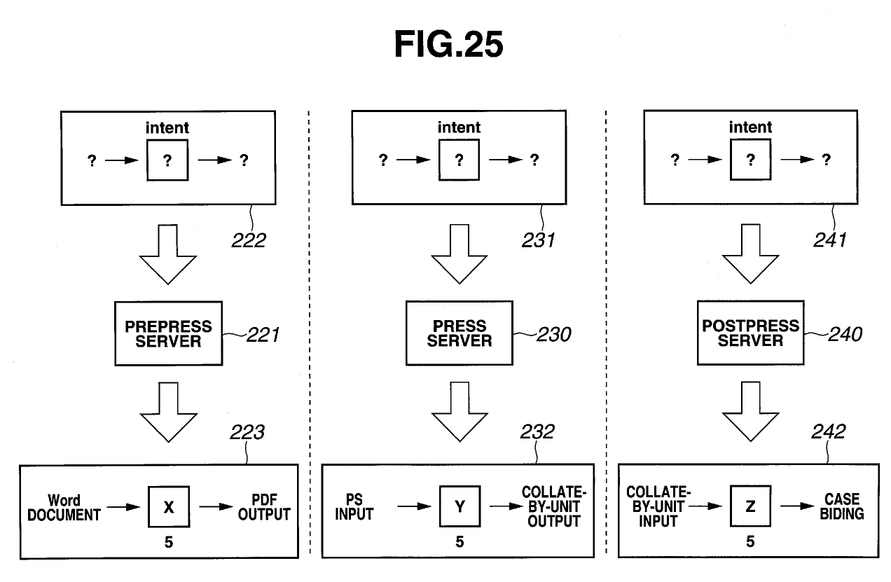

FIG. 25 illustrates exemplary result obtained when the MIS server 210 transmits an intermediate job ticket to each manager and each manager generates process information. More specifically, the MIS server 210 transmits intermediate job tickets 222, 231, and 241 to the prepress server 221, the press server 230, and the postpress server 240. Intent information described in the intermediate job ticket shown in FIG. 25 has the contents shown in FIG. 12.

The prepress server 221 extracts corresponding intent items from the database information described in FIG. 21 and generates process information satisfying the conditions described in the intermediate job ticket 222.

The prepress server 221 can recognize that an “input document file” is “manual.doc” based on the intent information contained in the intermediate job ticket. Accordingly, the prepress server 221 detects a system that can process a “.doc” file from the information described in FIG. 21. As a result, three devices (systems) X, V, and S are detected as candidate process systems.

Furthermore, the prepress server 221 recognizes that “finishing size: A4” is designated in the intermediate job ticket. Hence, the prepress server 221 specifies a system having A4-size processing capability from the information described in FIG. 21. As a result, four systems X, V, S, and P are detected. Similar processing is executed for a “desired bookbinding type”, and the prepress server 221 detects four systems X, V, S, and P.

According to the intermediate job ticket shown in FIG. 17, the “cost” has a lower limit value equal to “0”, an upper limit value equal to “infinite ”, and an effort direction value equal to “minus.” Namely, the prepress server 221 is required to select a system that can satisfy the conditions of the intent information shown in FIG. 12 and can perform the processing at the lowest “cost.”

As a result of system selection performed by the prepress server 221 based on the intermediate job ticket shown in FIG. 17, three systems X, V, and S can be detected as systems capable of satisfying the conditions including “input document file”, “finishing size”, and “desired bookbinding type.”

Furthermore, the intent information shown in FIG. 12 designates executing the processing at a lowest cost. Therefore, the prepress server selects the system X as a lowest-cost system based on the information described in FIG. 21, and specifies the system X as an optimum system that can execute the processing in the prepress process.

Accordingly, the prepress server 221 shown in FIG. 25 generates process information including the selected system X. Furthermore, the prepress server 221 generates process information 223 including “Worddocument” (i.e., input corresponding format of system X) as input conditions based on the selected system information and the intermediate job ticket.

Furthermore, the prepress server 221 generates process information 223 including “PDF output” (i.e., output corresponding format of system X) as output conditions. As the selected system X has an “average operation time (cost)” equal to “5”, the prepress server 221 generates process information 223 including the intent applicability set to be “5.”

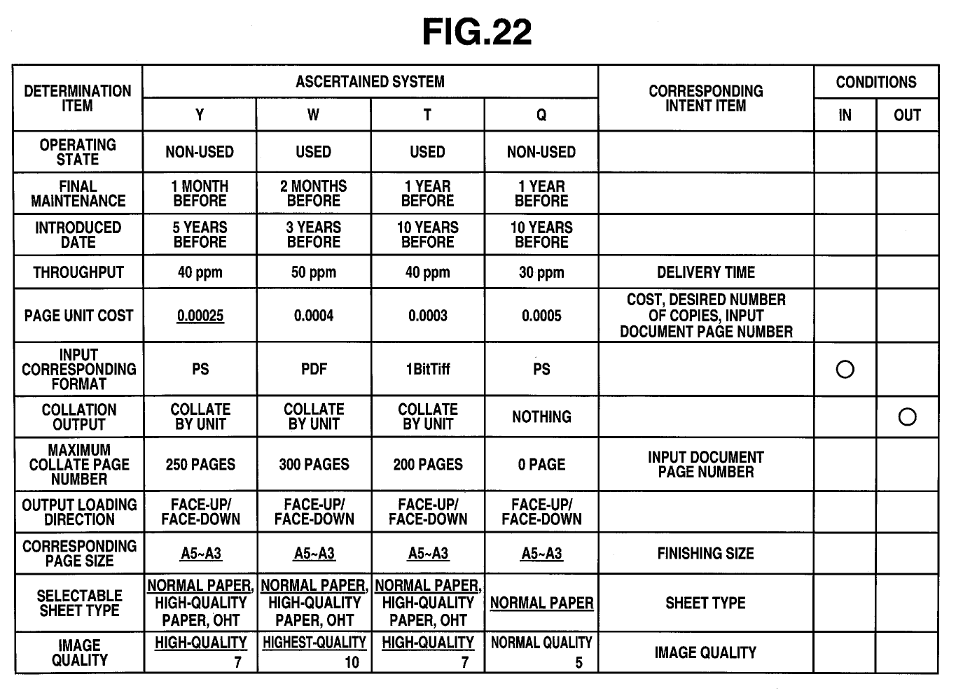

The press server 230 extracts corresponding intent items from the information described in FIG. 22 and generates process information satisfying the conditions of intent information contained in the intermediate job ticket shown in FIG. 18.

The press server 230 refers to “delivery time” in the intent information shown in FIG. 12. However, according to the intent information shown in FIG. 12, the delivery time is “infinite” that requires no processing. The press server 230 recognizes that the intent information shown in FIG. 12 designates a “finishing size” equal to “A4.” However, all devices ascertained by the press server 230 have A4-size processing capability. Thus, the press server 230 detects all devices.

Similar processing is executed for “image quality”, and the press server 230 recognizes that the “image quality” is set to “image quality level 6” in the intermediate job ticket. Therefore, the press server 230 detects devices V, W, and T having an image quality level equal to 6 or more higher level based on the information described in FIG. 22.

According to the intent information shown in FIG. 12, the “cost” has a lower limit value equal to “0”, an upper limit value equal to “infinite ”, and an effort direction value equal to “minus.” Namely, the press server 230 is required to select a device that can satisfy various conditions of the intent information shown in FIG. 12 and can perform the processing at the lowest “cost.”

As a result of system selection performed by the press server 230 based on the intent information shown in FIG. 12, three devices V, W, and T can be detected as devices capable of satisfying the conditions including “delivery time”, “finishing size”, and “image quality.”

Furthermore, the intent information designates executing the processing at a lower cost. Therefore, the press server 230 selects the device Y as a lowest-cost device based on the information described in FIG. 22, and specifies the device Y as an optimum device that can execute the processing in the press process.

Accordingly, the press server 230 shown in FIG. 25 generates process information including the selected device Y. Furthermore, the press server 230 generates process information 223 including “PS input” (i.e., input corresponding format of device Y) as input conditions based on the selected device information.

Furthermore, the press server 230 generates process information 232 including “collate-by-unit output” (i.e., collation output function of device Y) as output conditions. Furthermore, the press server 230 recognizes that a “cost per page” of the selected device Y is “0.00025” according to the information described in FIG. 22. The press server 230 can recognize that the desired number of copies is 100 and the page number is 200 pages based on the intent information shown in FIG. 12. The press server 230 calculates the cost by multiplying the “cost per page” with the total output page number in the intent information. In this case, the cost is “5” and accordingly the press server 230 generates process information 232 including the intent applicability set to be “5.”

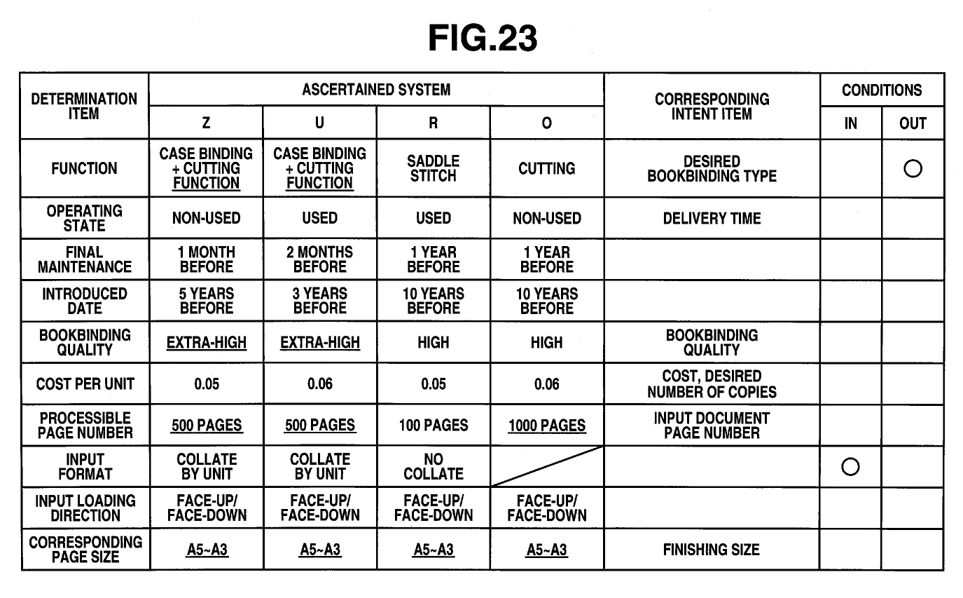

The postpress server 240 extracts corresponding intent items from the information described in FIG. 23 and generates process information satisfying the conditions of intent information contained in the intermediate job ticket shown in FIG. 19.

The postpress server 240 can recognize that a “desired bookbinding type” is “case binding” based on the intermediate job ticket shown in FIG. 19. Therefore, the postpress server 240 selects devices U and Z that can execute case binding processing based on the information described in FIG. 23.

Furthermore, the postpress server 240 recognizes that the intermediate job ticket shown in FIG. 19 includes a “bookbinding quality” designated to “extra high.” Accordingly, the postpress server 240 selects devices Z and U which have the “bookbinding quality” equal to “extra high”, with reference to the database information shown in FIG. 23.

The postpress server 240 can recognize an “input document page number” from the intermediate job ticket. The input document page number recognized by the postpress server 240 is 220 pages. The database information shown in FIG. 23 indicates that devices Z, U, and O can perform processing for obtaining the required output result.

As a result of device selection performed by the postpress server 240 based on the intermediate job ticket shown in FIG. 19, two devices Z and U can be detected as devices capable of satisfying the conditions including “desired bookbinding type”, “bookbinding quality”, and “input page number.”

Furthermore, the intent information designates executing the processing at a lowest cost. Therefore, the postpress server 240 selects the device Z as a lowest-cost device based on the information described in FIG. 23, and specifies the device Z as an optimum device that can execute the processing in the postpress process.

Accordingly, the postpress server 240 shown in FIG. 25 generates process information 242 including the selected device Z. Furthermore, the postpress server 240 generates process information including “collate-by-unit” (i.e., “input format” of device Z) as input conditions and “case binding” (i.e., output format of device Z) as output conditions based on the selected device information.

Furthermore, the device Z selected by the postpress server 240 has a “cost per unit” equal to “0.05.” The intent information shown in FIG. 12 includes the “desired number of copies” equal to “100.” Thus, the postpress server 240 generates process information 242 which includes the intent applicability set to be “5.”

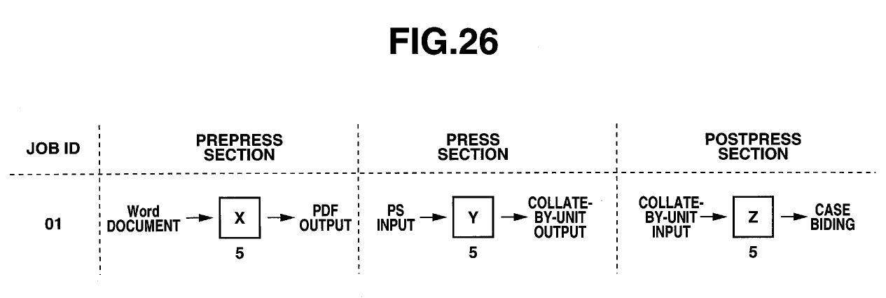

The process analysis section 305 in the MIS server 210 produces a process job ticket based on the process information received from each manager and stores the process job ticket to the database. In this case, the process job ticket is stored for each manager. FIG. 26 illustrates the state of the database 306 storing process job tickets produced by the process analysis section 305 based on the process information (223, 232, 242) received from respective managers.

First, the process analysis section 305 recognizes identification information (e.g., id=“job1” in the first row of FIG. 16) of the job ticket described in the analysis result (FIG. 16) of the intent information shown in FIG. 12 stored in the database 306 and the process described in the analysis result.

For example, if FIG. 16 shows the analysis result of object intent information, the process analysis section 305 determines that all of the prepress process, the press process, and the postpress process are required and executes in this order.

Subsequently, the process analysis section 305 refers to the process job tickets generated by respective managers. As shown in FIG. 26, the database 306 stores identification information (job ID) of a job ticket and process job tickets of respective processes generated by respective managers based on intermediate job tickets.

The process analysis section 305 determines whether the process job tickets of respective processes stored in the database as shown in FIG. 26 can be connected according to the description of FIG. 16. According to the example shown in FIG. 26, the prepress process and the press process are positioned next to each other.

However, an output format (PDF output) of the prepress process is different from an input format (PS input) of the press process. Therefore, the process analysis section 305 determines that a workflow for processing the intent information shown in FIG. 12 cannot be generated based on the process job tickets stored in the database as shown in FIG. 26.

On the other hand, the press process and the postpress process can satisfy input/output format requirements. Thus, the process analysis section 305 determines that the press process and the postpress process are connectable.

As a result, the process analysis section 305 determines that the process job ticket shown in FIG. 26 includes unconnectable processes (i.e., prepress process and press process) due to different input/output formats. Therefore, the workflow generating section 307 cannot generate a workflow for realizing the processing described in the intent information shown in FIG. 12.

Hence, the process analysis section 305 transmits, to the intermediate JT generating section 302, a job ticket ID and conditions of input/output information. The intermediate JT generating section 302 newly generates an intermediate job ticket based on information obtained from the process analysis section 305. The input/output conditions to be added are determined in the following manner.

Condition 1: input/output conditions, if causing no disagreement in connection requirements of a workflow, are used without any changes. For example, according to the example shown in FIG. 26, input conditions of the prepress section and output conditions of the press section are not changed.

Condition 2: if any disagreement is caused in connection requirements of a workflow, input/output conditions of one process are changed to agree with input/output conditions of the other process. More specifically, according to the example shown in FIG. 26, disagreement of input/output conditions is recognized in the connection between the prepress process and the press process of a workflow.

In this case, the output conditions of the prepress process are equalized to the input conditions of the press process. On the other hand, the input conditions of the press process can be equalized to the output conditions of the prepress process. As a result, the intermediate JT generating section 302 generates an intermediate job ticket including PS output (output conditions) for the prepress server and generates an intermediate job ticket including PDF input (input conditions) for the press server.

The intermediate JT generating section 302 transmits, to each manager, the intermediate job ticket regenerated based on the designation obtained from the process analysis section 305. Each manager executes processing for generating process information based on newly received intermediate job ticket. In this case, the intermediate job ticket received by each manager contains the above-mentioned information (Condition 1 and Condition 2).

Each manager generates process information based on the intermediate job ticket. The prepress server selects a system having an input format “Worddocument” and an output format “PS” with reference to the information described in FIG. 21. The press server selects a device having an input format “PDF” and an output format “collate-by-unit output.”

FIG. 27 illustrates the result of above-mentioned selection, wherein the conditions relating to the postpress server 240 are not changed, therefore, are not shown. Each manager transmits newly generated process information to the MIS. According to the example shown in FIG. 27, an intermediate job ticket including workflow generation conditions designating change of input conditions or output conditions is transmitted to each of the prepress manager and the press manager (i.e., two managers of the unconnectable processing processes).

However, the present embodiment is not limited to the above-mentioned processing. The process analysis section 305 can determine whether continuous processing processes can be connected based on the input conditions and the output conditions involved in respective processing content information generated by plural processing content determination apparatus.

In this case, if determined that no workflow can be generated, the process analysis section 305 can transmit an intermediate job ticket including workflow generation conditions designating change of input conditions or output conditions of at least one processing process of the continuous processing processes to a manager determining processing content of the processing process.

Alternatively, the process analysis section 305 can transmit a regenerated intermediate job ticket not designating change of input conditions or output conditions to any one of managers of continuous processing processes.

Newly obtained process information can be stored in the database 306. FIG. 28 illustrates information stored in the database including additional process conditions resulting from re-conversion. As shown in FIG. 28, the database 306 can store a generated process job ticket.

The process analysis section 305 newly determines processes connectable to form a workflow based on the stored contents shown in FIG. 28. According to the example shown in FIG. 28, the process analysis section 305 can recognize a combination of “system X device W device Z” or “system V device Y device Z” as a connectable workflow and can determine that generation of a workflow is possible. The determination result is transmitted to the workflow generating section 307. The workflow generating section 307 executes processing for generating a workflow.

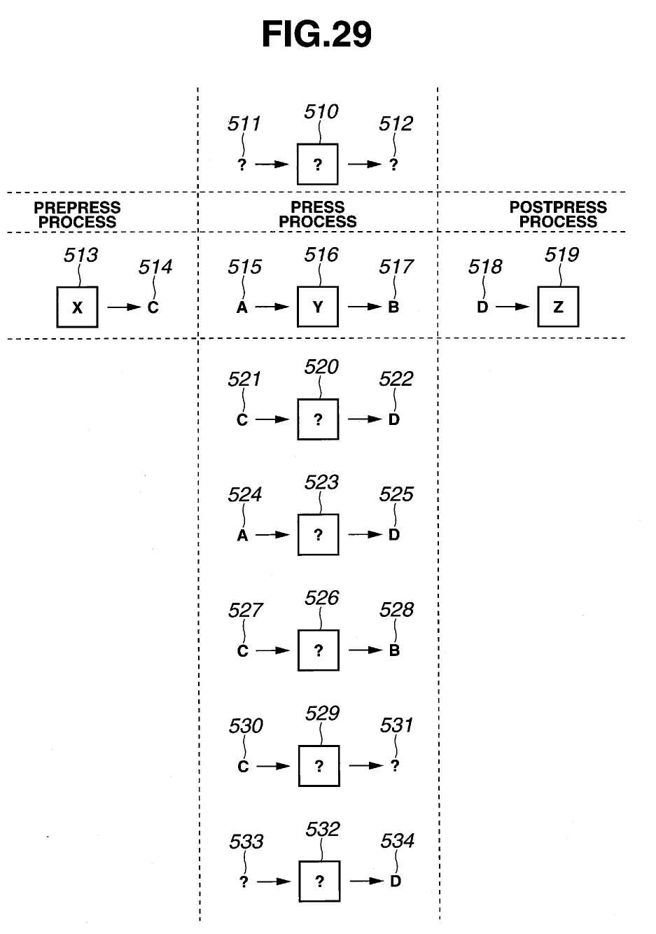

However, desired conversion result may not be obtained even if a generated intermediate job ticket designates input/output conditions. If there is no device or parameter settings satisfying designated conditions, information relating to processes connectable to form a workflow cannot be obtained. The processing performed in this case is described with reference to FIG. 29. FIG. 29 shows a press server as an object, although the object is not limited to the example shown in the drawing.

FIG. 29 illustrates exemplary pattern for changing designation of input/output conditions. Intermediate job tickets 510 through 512 include no designation of conditions. FIG. 29 shows corresponding conversion results 515 through 517, conversion results 513 and 514 (output side) in a pre-process, and conversion results 518 and 519 (input side) in a post-process.

As shown in FIG. 29, input condition 515 (i.e., “A”) of the device Y disagrees with output condition 514 (i.e., “C”) of the pre-process device X. Furthermore, output condition 517 (i.e., “B”) of the device Y disagrees with input conditions 518 (i.e., “Z”) of the post-process device Z.

Hence, the intermediate JT generating section 302 generates intermediate job tickets 520 through 522 including designated input/output conditions. However, if the press server cannot select a device having input/output conditions satisfying the designated intermediate job ticket, a notice informing no generation of process information is transmitted to the intermediate JT generating section 302. As a result, the intermediate JT generating section 302 successively generates intermediate job tickets according to the following patterns.

Pattern 1: the intermediate JT generating section 302 designates input conditions of process information stored in the database, and generates an intermediate job ticket designating output conditions agreeing with input conditions of process information in the post-process. According to the example shown in FIG. 29, the intermediate JT generating section 302 designates input condition “A” based on the process information 515 through 517 and generates an intermediate job ticket (including information 523 through 525) designating output condition “D” based on the process information 515 through 517.

Pattern 2: the intermediate JT generating section 302 designates output conditions of process information stored in the database, and generates an intermediate job ticket designating input conditions agreeing with output conditions of process information in the pre-process. According to the example shown in FIG. 29, the intermediate JT generating section 302 designates output condition “B” based on the process information 515 through 517, and generates an intermediate job ticket (including information 526 through 528) designating output condition “C” based on the process information 513 and 514.

Pattern 3: the intermediate JT generating section 302 generates an intermediate job ticket designating only input conditions based on the output conditions of the process information in the pre-process stored in the database. According to the example shown in FIG. 29, the intermediate JT generating section 302 generates an intermediate job ticket (including information 529 through 531) designating input conditions agreeing with the output conditions of the process information 513 through 514.

Pattern 4: the intermediate JT generating section 302 generates an intermediate job ticket designating only output conditions based on the input conditions of the process information in the post-process stored in the database. According to the example shown in FIG. 29, the intermediate JT generating section 302 generates an intermediate job ticket (including information 532 through 534) designating output conditions agreeing with input conditions of the process information 518 and 519.

Each server receives the intermediate job ticket generated according to any one of the abovementioned patterns and selects a device capable of realizing the processing content described in each intermediate job ticket, and regenerates process information. Then, the press server transmits the regenerated process information to the MIS. A process job ticket based on the regenerated process information can be stored in the database.

The process analysis section 305 newly searches a combination of processes connectable to form a workflow. More specifically, each manager may transmit new process job ticket based on an intermediate job ticket regenerated according to the pattern shown in FIG. 29. The process analysis section 305 determines whether there is any combining of processes connectable to form a workflow based on the newly generated process job ticket and the formerly generated process job ticket.

If the process analysis section 305 determines that the method described with reference to FIG. 29 cannot generate any workflow, the intermediate JT generating section 302 regenerates an intermediate job ticket loosening the conditions of intent information and transmits the regenerated job ticket to each manager.

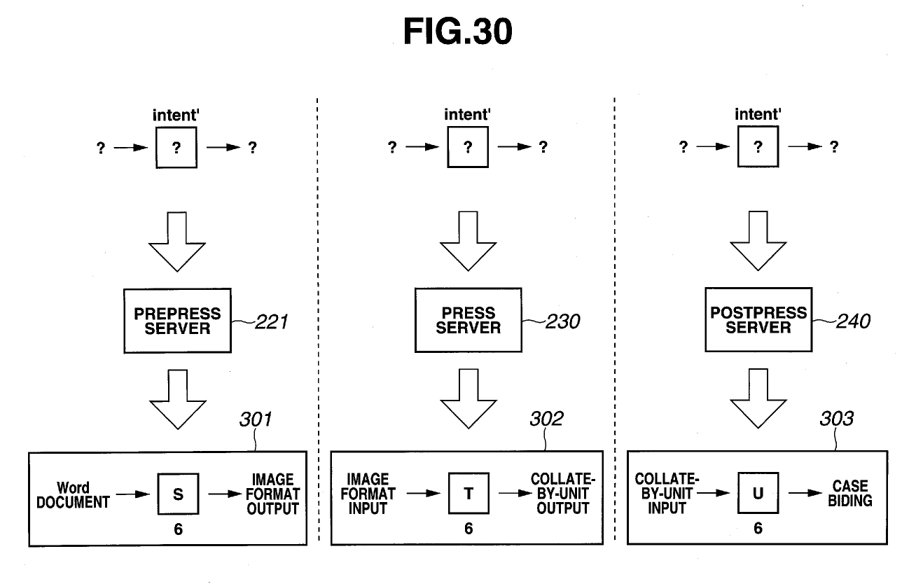

FIG. 30 illustrates exemplary result of process information generated by respective managers based on an intermediate job ticket loosening the conditions of intent information. As shown in FIG. 30, the intermediate JT generating section 302 transmits an intermediate job ticket “Intent′” including relaxed conditions. The job ticket “Intent′” according to the present embodiment relaxes the cost conditions (i.e., intent information of effort direction value shown in FIG. 12). As a result, process information containing modified input/output conditions and device information can be generated.

Furthermore, the intent applicability of the cost in each manager is decreased compared to the previous value (i.e., the cost is increased). Namely, loosening the intent conditions enables the intermediate JT generating section 302 to select system S which could not be selected because of the cost higher than that of the system X as shown in the information described in FIG. 21.

As a result, the prepress server can generate process information 301 shown in FIG. 30. Similarly, the press server can select a device T and generate process information 302. In this manner, loosening the conditions contained in intent information can increase the degree of a freedom in selecting candidate systems (or devices) in each manager. The MIS can receive an increased number of process job tickets.

In this manner, as a result of loosening the conditions of intent information, many and various process information can be generated and an increased number of combinations can be obtained. Thus, the possibility of establishing a workflow can be increased.

The MIS server 210 receives a process job ticket returned based on the intermediate job ticket loosening the intent conditions and stores the received process job ticket in the database 306. The process analysis section 305 determines whether a workflow can be generated based on process job tickets relating to a present target job which are selected from all process job tickets stored in the database 306.

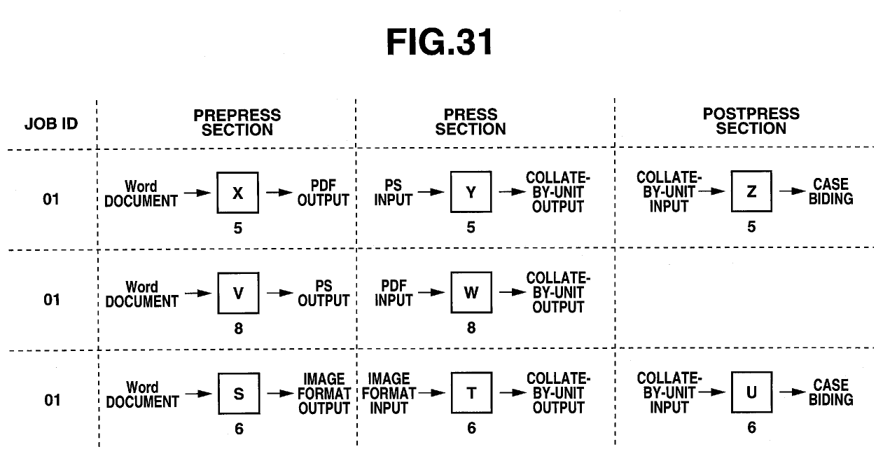

If the process analysis section 305 determines that a workflow can be generated, the workflow generating section 307 selects a process job ticket having an optimum combination for the intent information. The workflow generating section 307 determines the optimum combination based on the intent applicability of each process in the generated workflow. For example, when the process information of respective processes are stored as shown in FIG. 31, the workflow generating section 307 selects a combination of system S, device T, and device Z because the selected combination is lowest in the cost.

On the other hand, if the process analysis section 305 determines that no workflow can be generated based on relaxed intent conditions, an intermediate job ticket including more loosening intent conditions is generated and transmitted to each manager. More specifically, the intermediate JT generating section 302 can stepwise relax the intent conditions.

The processing shown in FIG. 29 and the processing for loosening the intent conditions can be executed when it is determined that a workflow cannot be generated based on the description shown in FIG. 28. However, the invention is not limited to the present embodiment.

For example, when the processing shown in FIGS. 25 and 26 cannot generate a workflow, the processing for loosening the intent conditions can be executed. Although according to FIG. 31 a workflow can be generated by executing the processing shown in FIG. 28, FIG. 31 shows the result obtained by executing the processing for loosening the intent conditions.

If the process analysis section 305 determines that a workflow can be generated, the process analysis section 305 can transmit only the determination result to the workflow generating section 307 so that the workflow generating section 307 can select process information. Alternatively, if the process analysis section 305 determines that a workflow can be generated, the process analysis section 305 can transmit a combination of process information to the workflow generating section 307.

### [Intent Condition Loosening Method]

The processing is described below when the intermediate JT generating section 302 determines that loosening the conditions contained in intent information is necessary. In the intent information, the intermediate JT generating section 302 relaxes the conditions of an item including an effort direction value.

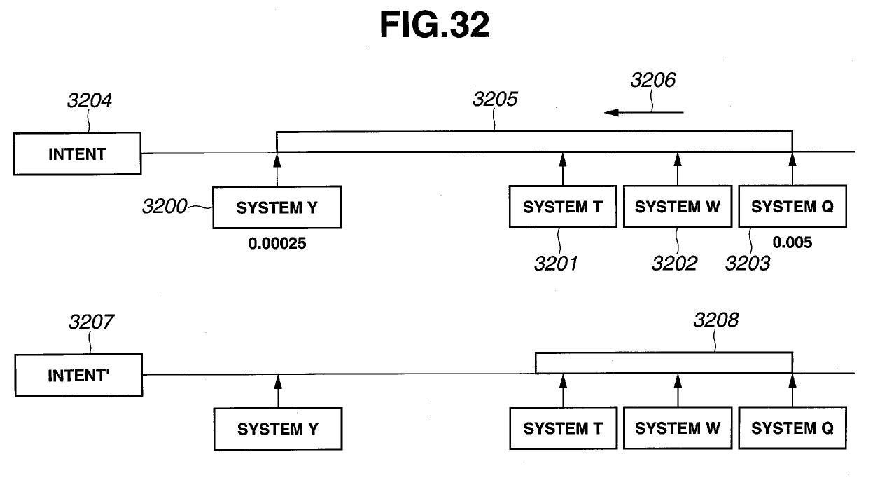

FIG. 32 illustrates an intent condition loosening method employable when the intent information designates a minus effort direction value.

In FIG. 32, intent information 3204 is received from the order section. The intent information 3204 corresponds to the information described in FIG. 12. FIG. 32 includes a numerical line representing a cost value range and a numerical line representing effort direction value designated in the intent information. According to the example shown in FIG. 32, the press server selects a device executing a press process.

In FIG. 32, system 3200 corresponds to the lowest-cost device Y ascertained by the press server. System 3203 corresponds to the highest-cost device Q ascertained by the press server. Similarly, system 3201 corresponds to the device T and system 3202 corresponds to the device W. Intent condition 3205 is designated by intent information 3204. Effort direction value 3206 is a minus direction. Thus, the press server selects the device Y.

The intermediate JT generating section 302 generates an intermediate job ticket containing intent information 3207 which is generated by loosening intent conditions. The intent information 3207 includes intent condition 3208 changed from the intent condition 3205 as a result of relaxation of intent conditions.

The intermediate JT generating section 302 generates an intermediate job ticket including intent conditions modified so as to exclude a presently selected device with respect to the cost. As a result, the press server can select the device T in response to reception of the intermediate job ticket containing the intent information 3207.

Although FIG. 32 illustrates conversion from the intent condition 3205 to intent condition 3208, the intermediate JT generating section 302 generates an intermediate job ticket by stepwise changing intent conditions More specifically, when the process analysis section 305 determines that no workflow can be generated based on a process job ticket generated from an intermediate job ticket containing relaxed intent conditions, the intermediate JT generating section 302 generates intermediate job ticket further loosening the intent conditions.

The intermediate JT generating section 302 can repeatedly (or predetermined times) execute the above-mentioned loosening processing until a workflow can be formed by connecting processes based on the relaxed intent conditions. The processing for a plus effort direction value is similar to the above-mentioned processing for the minus effort direction value and therefore, description is not repeated.

### [Workflow Job Ticket]

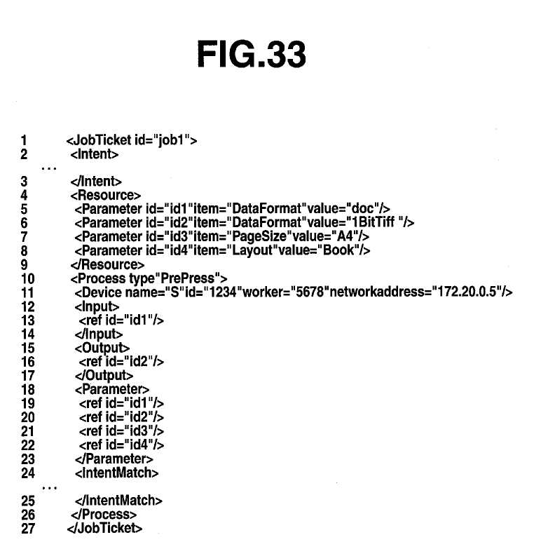

When the process analysis section 305 determines that a workflow can be generated, the workflow generating section 307 generates a workflow job ticket expressing a workflow including selected process job tickets merged (combined) with each other. The merge processing performed by the workflow generating section 307 is described bellow with reference to FIGS. 33 through 36. In this case, the process job tickets to be combined are notified beforehand from the process analysis section 305 to the workflow generating section 307.

FIGS. 33 through 35 are exemplary job tickets of respective processes generated based on process job tickets selected from the database 306 for generating an optimum workflow. According to the exemplary job tickets shown in FIGS. 33 through 35, the selected process job tickets are a combination of the system S, the device T, and the device Z described in FIG. 31.

The workflow generating section 307 generates a prepress process job ticket shown in FIG. 33 based on the process job ticket containing the system S (i.e., input format: Worddocument, output format: Imageformat output).

The eighth through fifteenth rows of FIG. 16 do not describe parameters relating to the prepress process because a system executing the prepress process is not yet determined. However, the workflow generating section 307 can determine four parameters shown in fifth through eighth rows shown in FIG. 33 based on the process information 301 shown in FIG. 30, selected from the process information generated through the processing shown in FIGS. 25, 27, and 30.

The thirteenth row of FIG. 33 includes description referring to parameters described in the fifth row, i.e., input conditions of the prepress process (“DataFormat” value=“doc”) Then, the sixteenth row of FIG. 33 includes description referring to parameters described in the sixth row, i.e., output conditions of the prepress process (“DataFormat” value “1BitTiff”).

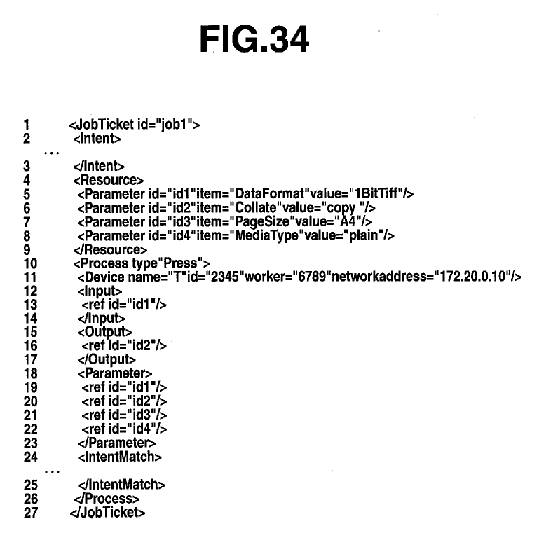

Subsequently, the workflow generating section 307 generates a press process job ticket shown in FIG. 34 based on the process job ticket containing the device T (input format: Imageformat input, output format: collate-by-unit output) in the press process.

The sixteenth through twenty-third rows of FIG. 16 do not describe parameters relating to the press process because a device executing the press process is not yet determined. However, the workflow generating section 307 can determine four parameters shown in fifth through eighth rows shown in FIG. 34 based on the process information 302 shown in FIG. 30.

The thirteenth row of FIG. 34 includes description referring to parameters described in the fifth row, i.e., input conditions of the press process (“DataFormat” value=“1BitTiff”). Then, the sixteenth row of FIG. 34 includes description referring to parameters described in the sixth row, i.e., output conditions of the press process (“Collate” value=“Copy”).

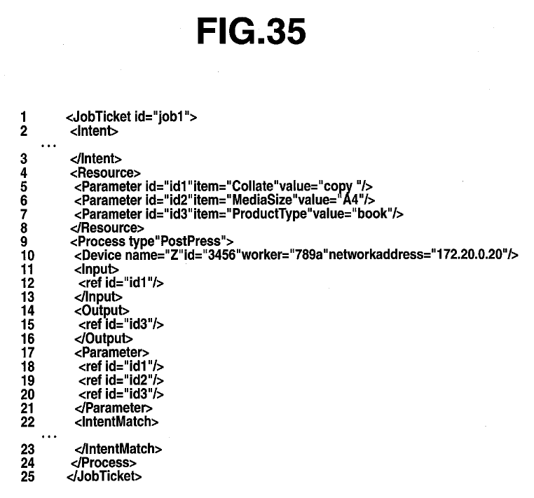

Subsequently, the workflow generating section 307 executes processing for the postpress process which is similar to the processing described with reference to FIGS. 33 and 34. The twelfth row of FIG. 35 includes description referring to parameters described in the fifth row, i.e., input conditions of the postpress process (“Collate” value=“copy”). Then, the fifteenth row of FIG. 35 includes description referring to parameters described in the seventh row, i.e., output conditions of the postpress process (“ProductType” value=“book”).

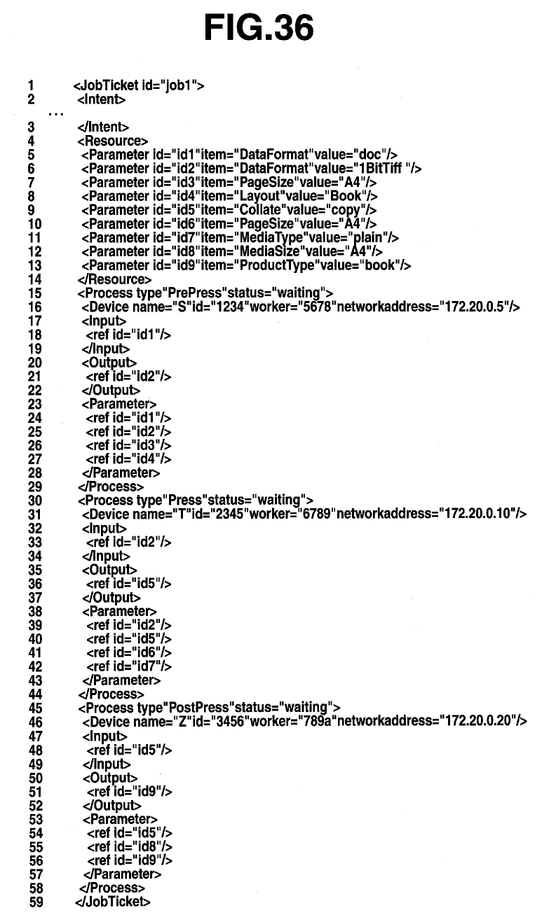

FIG. 36 illustrates exemplary workflow job ticket including the process job tickets shown in FIGS. 33 through 35. The workflow job ticket of the present embodiment includes two merge points. One merge point is re-allocation of identifiers for parameter description. The other merge point is forming combination so as to refer to same parameter identifiers at an agreement portion of input/output conditions forming a workflow.

The merge procedure for generating the workflow job ticket shown in FIG. 36 is described below. The workflow generating section 307 can generate a workflow job ticket by combining job tickets of respective processes.

First through third rows of FIG. 36 are similar to the job tickets shown in FIGS. 33 through 35. Accordingly, the workflow generating section 307 copies the first through third rows of the job ticket shown in FIG. 33 (including intent description portion (not shown)). Next, the workflow generating section 307 describes the fourth through twenty-sixth rows shown in FIG. 33 into the workflow job ticket as shown in FIG. 36. As a result, fifth through eighth rows of FIG. 36 reflect the contents of FIG. 33.

The workflow generating section 307 describes the contents of job ticket ranging from the tenth row to through twenty-sixth row of FIG. 33 (except for the intent applicability described in twenty-fourth and twenty-fifth rows) into the job ticket as shown in FIG. 36. The described portion corresponds to the fifteenth through twenty-ninth rows of FIG. 36. Furthermore, FIG. 36 includes description “status=“waiting” added to the fifteenth row, which is later used for state management of the workflow control.

Next, the workflow generating section 307 merges the job ticket shown in FIG. 34 into the workflow job ticket. The workflow generating section 307 equalizes the input/output conditions of the press process (i.e., a present object) and the prepress process (pre-process). The pre-process is described in the job ticket shown in FIG. 33. As the selected job tickets are combined so as to form a workflow, the output conditions of the pre-process job ticket shown in FIG. 33 agree with the input conditions of the job ticket shown in FIG. 34.

The output conditions of the job ticket shown in FIG. 33 are described in the sixth row which can be referred to by the description of twenty-first row shown in FIG. 36. The input conditions of the job ticket shown in FIG. 34 are described in the fifth row which can be referred to by the description of sixteenth row shown in FIG. 34.

The workflow generating section 307 integrates the description of the fifth row of FIG. 34 and the description of the sixth row of FIG. 36. The workflow generating section 307 describes, based on the integration processing, the contents of fourth through twenty-sixth rows of FIG. 34 into the workflow job ticket as shown in FIG. 36.

The workflow generating section 307 deletes the description of twenty-fourth and twenty-fifth rows of FIG. 34 (i.e., intent applicability) in the same manner as the processing described for FIG. 33. The workflow generating section 307 reallocates (and describes) the identifiers for the fifth through eighth rows of FIG. 34 so as to prevent the same identifier(s) from being used for the above-mentioned integration work and the resource.

Namely, the fifth row of FIG. 34 corresponds to the sixth row of FIG. 36. The sixth row of FIG. 34 includes the contents described in the row including “id5” in FIG. 36. Thus, the sixth row of FIG. 34 is rewritten to id=“id5” and described in the ninth row of FIG. 36. Similarly, the seventh row of FIG. 34 is rewritten to “id=“id6” and described in the tenth row of FIG. 36. The eighth row of FIG. 34 is rewritten to id=“id7” and described in the eleventh row of FIG. 36.

When the identifiers of the resource description are updated, identifiers of the description referring to the updated identifiers are updated. To this end, the workflow generating section 307 generates a workflow job ticket including an identifier“id=“id2” rewritten from the thirteenth row of FIG. 34.

Similarly, the workflow job ticket shown in FIG. 36 includes thirty-sixth row corresponding to the sixteenth row of FIG. 34, thirty-ninth row corresponding to the nineteenth row of FIG. 34, fortieth row corresponding to the twentieth row of FIG. 34, forty-first row corresponding to the twenty-first row of FIG. 34, and forty-second row corresponding to the twenty-second row of FIG. 34. Furthermore, similar to processing performed for the example shown in FIG. 33, description status=“waiting” is added to thirtieth row of FIG. 36.

Finally, the workflow generating section 307 merges the job ticket shown in FIG. 35 into the workflow job ticket according to a procedure similar to that used for the job ticket shown in FIG. 34. The workflow generating section 307 integrates the agreement portions of input/output conditions, and describes additional resource description so as not to use the same identifier(s) as that (those) of the existing description.

The workflow job ticket shown in FIG. 36 includes ninth row describing identifier id=“id5” modified from the fifth row of FIG. 35, twelfth row describing identifier id=“id8” modified from the sixth row of FIG. 35, thirteenth row describing identifier id=“id9” modified from the seventh row of FIG. 35, forty-eighth row describing identifier id=“id5” modified from the twelfth row of FIG. 35, and fifty-first row describing identifier id=“id9” modified from the fifteenth row of FIG. 35.

Furthermore, the workflow job ticket shown in FIG. 36 includes fifty-fourth row describing identifier id=“id5” modified from the eighteenth row of FIG. 35, fifty-fifth row describing identifier id=“id8” modified from the nineteenth row of FIG. 35, and fifty-sixth row describing identifier id=“id9” modified from the twentieth row of FIG. 35. Furthermore, similar to processing performed for the example shown in FIG. 33, description status=“waiting” is added to forty-fifth row of FIG. 36.

As described above, the workflow job ticket shown in FIG. 36 can be generated based on the job tickets of respective processes shown in FIGS. 33 through 35. The workflow control section 308 shown in FIG. 14 instruct each manager to execute output processing according to the generated workflow job ticket. In this case, the workflow control section 308 can transmit a common workflow job ticket including all processes (as shown in FIG. 36) to each manager. Alternatively, the workflow control section 308 can transmit only related portion (refer to FIGS. 33 through 35) of the workflow job ticket to each manager.

### [Flow of Processing]

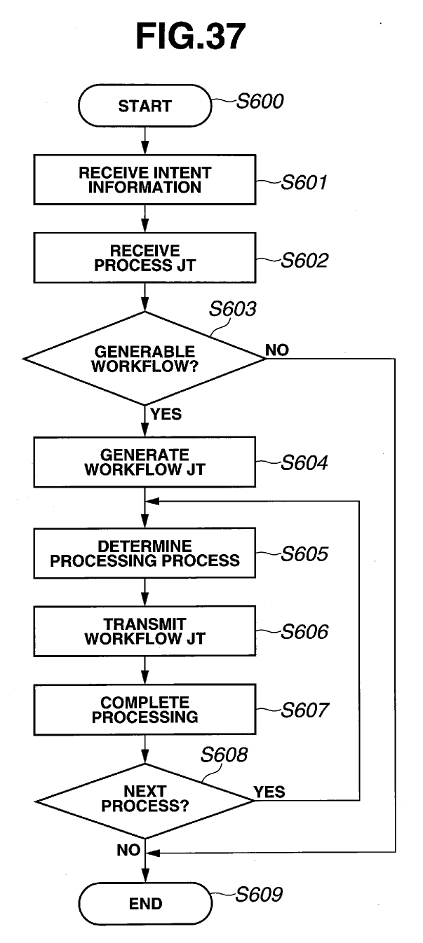

FIG. 37 is a flowchart illustrating exemplary procedure of the print bookbinding processing according to the present embodiment. The MIS server includes a central processing unit (CPU) that can execute the processing of each step described in the flowcharts of FIGS. 37 through 39.

The process starts at S600. The communication section 300 receives an intent job ticket (refer to FIG. 15) from the order section (refer to step S601). The MIS generates an intermediate job ticket based on the received intent job ticket and transmits the generated intermediate job ticket to the manager of each process. The intermediate job ticket can be generated according to the method explained with reference to FIGS. 17 through 19, therefore, the method is not described here.

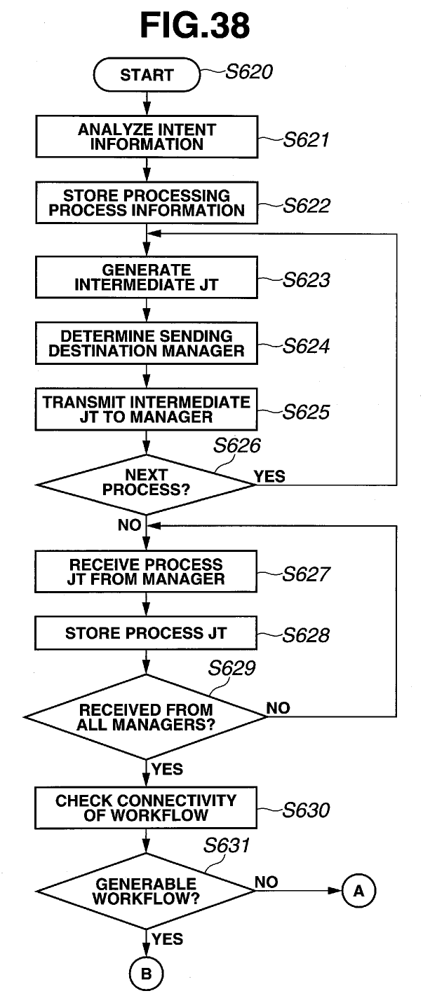

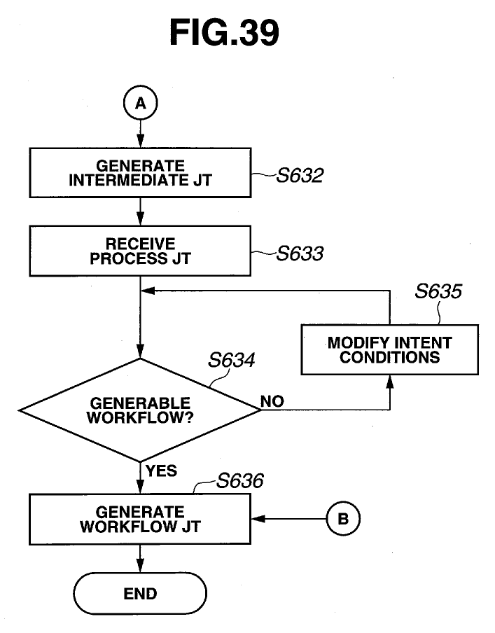

The communication section 304 receives a process job ticket (refer to FIG. 20) converted by the manager of each process (refer to step S602). The processing for converting intent information to process information will be described in detail with reference to FIGS. 38 and 39.

The process analysis section 305 determines whether a workflow can be generated based on process job tickets received from respective managers (refer to step S603). The processing of the step S603 can be performed as described with reference to FIGS. 25 through 31, therefore, is not described here. If there is a generable workflow (Yes in step S603), the process proceeds to step S604, otherwise the process terminates at step S609.

The workflow generating section 307 generates a workflow job ticket (refer to FIG. 36) based on the process information stored in the database 306 (refer to step S604). The workflow control section 308 determines a processing process based on the status information of the workflow job ticket (refer to step S605).

The processing process can be determined by successively selecting status information indicating “unprocessed” from the workflow processes. The status information is, for example, description of status=“waiting” as shown in fifteenth, thirtieth, and forty-fifth rows of FIG. 36.

If the “status” value is “waiting”, the process is in an unprocessed state. Accordingly, the workflow control section 308 designates each “unprocessed” process as a target processing process.

The communication section 304 transmits the workflow job ticket shown in FIG. 36 to the manager of a processing process determined by the processing of step S605 (refer to step S606). Each manager completes the processing based on the workflow job ticket. The workflow control section 308 receives a processing completion notice via the communication section 304 from each manager and updates the status information of the workflow job ticket (refer to step S607). For example, when a processing completion notice is received from the prepress manager, the “status” value in the fifteenth row of FIG. 36 is rewritten to “complete.”

The workflow control section 308 determines whether any unprocessed process is present (refer to step S608). The processing flow returns to step S605 if any unprocessed process is present. When the processing of all processes is completed, i.e., when the “status” value of each process is rewritten to “complete”, the processing flow proceeds to step S609 to terminate the processing of this routine.

Upon completing the processing of all processes, the workflow control section 308 sends a processing completion notice via the communication section 300 to the order section. Although the example shown in FIG. 37 transmits the workflow job ticket for each process, the workflow job ticket can be simultaneously transmitted to all processes.

FIG. 38 is a flowchart illustrating exemplary processing performed by the MIS to generate a workflow job ticket based on intent information.

The process starts at step S620. The intent analysis section 301 analyzes an intent JT (refer to FIG. 15), and determines a process or processes required to execute the processing described in the intent JT (refer to step S621). Namely, the MIS receives setting information for obtaining an output result. The intent analysis section 301 determines necessary processes based on the intent JT and the information described in FIG. 42. The intent analysis section 301 can execute the processing of step S621 as described with reference to FIGS. 15, 16, and 43, therefore, the processing is not described here.

The intent analysis section 301 stores processing process information (i.e., information obtained by analyzing the intent JT) into the database 306 (refer to step S622). The intermediate JT generating section 302 generates an intermediate job ticket (refer to step S623).

The intermediate JT generating section 302 refers to the information stored in the database 306 and recognizes the processing process information obtained from the analysis of the intent analysis section 301. Then, the intermediate JT generating section 302 generates intermediate job tickets (refer to FIGS. 17 through 19) based on the recognized process information.

The communication section 304 determines a sending destination of each intermediate job ticket with reference to the intermediate job ticket generated through the processing of step S623 (refer to step S624). The intermediate job ticket includes description relating to a processing process (e.g., twenty-second row of FIG. 17). Therefore, the communication section 304 can determine a sending destination of each intermediate job ticket. The communication section 304 transmits each intermediate job ticket to the sending destination determined through the processing of step S624 (refer to step S625).

The intermediate JT generating section 302 determines whether there is the next process (refer to step S626). If the next process is present, the processing flow returns to step S623 to generate an intermediate job ticket for the next process. On the other hand, if the intermediate JT generating section 302 determines that there is no process to be processed (i.e., NO in step S626), the processing flow proceeds to step S627 to receive conversion result (process information) from respective managers.

The communication section 304 receives process information from the manager of each process (refer to step S627). The process job ticket received from the communication section 304 is stored in the database 306 (refer to step S628). The process analysis section 305 determines whether the process information is received from all managers, with reference to the information stored in the database 306 (refer to step S629)

The process analysis section 305 refers to the analysis result obtained in the step S621 and can recognize a process required for each identification information involved in the job ticket. For example, the process analysis section 305 can recognize required processes (i.e., prepress process, press process, and postpress process) and job ticket identification information (JobTicket=job1) based on the analysis result shown in FIG. 16.

Furthermore, the database 306 stores the process job tickets generated by the managers of respective processes as shown in FIG. 26. The process analysis section 305 refers to identification information contained in the process job ticket stored in the database 306, and determines whether the process job tickets of all processes are received based on the process information shown in FIG. 26 and the analysis result shown in FIG. 16.

For example, FIG. 16 illustrates three processes. Therefore, the process analysis section 305 can execute the processing of step S629 by determining whether the process information describing the same job ticket identification information (JobTicket =job1) is collected for each process type (i.e., three types according to the present embodiment)

If all process job tickets are received, the processing flow proceeds to step S630. When there is any manager that has not yet transmitted a process job ticket, the processing flow returns to step S627.

The process analysis section 305 determines whether a workflow can be formed by connecting (combining) process job tickets of respective processes stored in the database 306 (refer to step S630). More specifically, based on the processing result obtained in S621 and S622, the database stores the analysis result shown in FIG. 16 which describes the processes required for processing the intent information received from the order section, and the processing order.

The process analysis section 305 determines whether any disagreement of input/output formats is present between two processes to be continuously processed, with reference to the analysis result of FIG. 16 stored the database and the input/output format information described in the process job tickets stored in the database 306.

For example, according to the example shown in FIG. 26, each process stores single process information. The output format (PDF output) of the prepress process disagrees with the input format (PS input) of the press process. Thus, the process analysis section 305 determines that no workflow can be formed.

On the other hand, the example shown in FIG. 28 stores an increased number of process job tickets compared to the example shown in FIG. 26. Hence, the process analysis section 305 can combine a process job ticket containing the device V, a process job ticket containing the device Y, and a process job ticket containing the device Z. The process analysis section 305 determines that a workflow can be generated.

Alternatively, the process analysis section 305 can combine a process job ticket containing the device X, a process job ticket containing the device W, and a process job ticket containing the device Z. The process analysis section 305 determines that a workflow can be generated.

Furthermore, the process analysis section 305 can refer to the process information of each process and can determine whether imposition processing is executed in plural processes to determine whether a workflow can be generated. For example, the imposition processing can be performed in both the prepress process and the press process.

For example, the prepress process may execute imposition processing and the press process may further execute imposition processing based on the imposition performed for output result of the prepress process. If imposition processing is executed in both processes, the imposition for the output result may be different from an expected one.

Accordingly, if plural processes execute imposition processing, the process analysis section 305 determines that generating a workflow is unfeasible.

The process analysis section 305 transmits the generated intermediate job ticket to plural managers. The process analysis section 305 determines whether a workflow for obtaining an intended output result can be generated by combining processing content information including input conditions and output conditions of respective processing processes generated by plural managers. Furthermore, the process analysis section 305 determines whether a workflow can be generated based on the information relating to execution of imposition processing contained in the process job tickets generated by plural managers.

In step S631, if the process analysis section 305 determines that the process job tickets include disagreement of input/output conditions, the processing flow proceeds to step S632. If the process analysis section 305 determines that a workflow is generable, the processing flow proceeds to S636.

If it is determined in step S631 that a workflow cannot be generated, in step S632, the intermediate JT generating section 302 regenerates processing content generating instruction information containing new workflow generation conditions to generate a workflow according to the information sent from the process analysis section 305, as described with reference to FIGS. 27 through 29. The communication section 304 receives a process job ticket based on the regenerated intermediate job ticket from each manager (refer to step S633) The received process job tickets are stored in the database.

The process analysis section 305 refers to the information stored in the database and determines again whether a workflow can be generated based on the process job tickets generated by respective managers according to the regenerated intermediate job tickets (refer to step S634), as described in step S631. Details are described in step S631, therefore, are not repeated here. If no workflow can be generated based the process job tickets produced from the regenerated intermediate job tickets (i.e., NO in step S634), the intermediate JT generating section 302 regenerates an intermediate job ticket containing modified intent conditions and transmits the regenerated intermediate job ticket to each manager (refer to step S635).

The method for modifying the intent conditions can include the above-described processing for loosening the intent conditions (refer to FIG. 30). The communication section 304 transmits the regenerated intermediate job ticket, for example, to the processing content determination apparatus, i.e., a transmission source of processing content information (process job ticket) that is identified as a cause of denial in the determination step S631.

When the process analysis section 305 receives process information based on the intermediate job ticket generated in step S635, the process analysis section 305 again executes the determination processing in S634.

If the process analysis section 305 determines that a workflow is generable in the determination step S634, the workflow generating section 307 generates a workflow job ticket (refer to FIG. 36) based on optimum process information for the intent information (refer to step S636).

More specifically, the workflow generating section 307 generates a workflow for obtaining an output result according to the determination result of re-determination processing (refer to step S634) based on the process information re-received from the manager that received an intermediate job ticket at step S635. When the process analysis section 305 determines that a workflow is generable, the workflow generating section 307 generates a workflow job ticket using at least one of process job tickets generated by the plural managers and transmits the generated workflow job ticket to the managers.

Through the processing described in FIGS. 38 and 39, the MIS server can generate a workflow based on the contents described in the intent job tickets received from the order section even in a situation that the systems of respective processes cannot communicate with each other or cannot obtain information of other processes. If a workflow for executing the contents described in the intent job ticket cannot be generated, an intermediate job ticket including additional various conditions can be regenerated to generate a workflow.

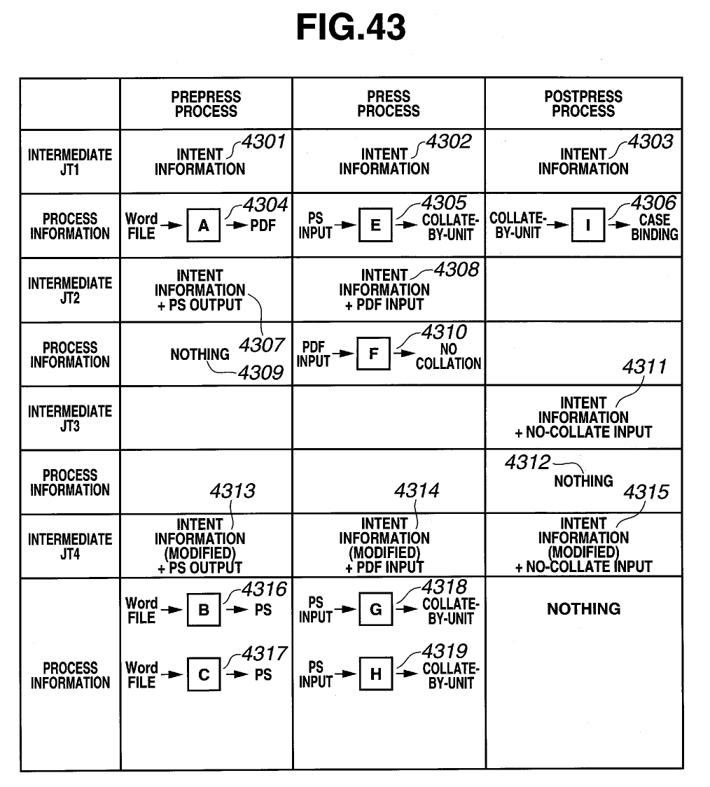

Another exemplary flow of processing is described in detail with reference to FIG. 43. It is now assumed that the intent analysis section 301 determines that a received intent job ticket requires three processes (i.e., prepress process, press process, and postpress process).

The intermediate JT generating section 302 generates intermediate job tickets 4301 through 4303 based on the received intent job ticket. The intermediate job ticket 1 (4301 through 4303) includes description relating to setting information of intent information that the MIS has received from the order section.

The manager of each process receives the intermediate job ticket 1 generated by the intermediate JT generating section 302. The manager of each process determines processing content of each process based on the intermediate job ticket 1 and system information ascertained by each manager and generates process information (4304 through 4306). The process analysis section 305 analyzes the process job ticket produced based on the process information generated by each manager and determines whether a workflow is generable.

According to the process job ticket (4304 through 4306) generated based on the intermediate job ticket 1, the output format of the prepress process is PDF and the input format of the press process is PS input. Thus, the input/output formats disagree with each other. Hence, the process analysis section 305 determines that no workflow is generable.

In response to the determination result, the intermediate JT generating section 302 generates intermediate job ticket 2 (4307 and 4308) containing new conditions. The prepress server intermediate job ticket 4307 includes PS output format as newly added conditions. The press server intermediate job ticket 4308 includes PDF input format as newly added conditions. The intermediate job ticket 2, containing newly added conditions, is transmitted to the manager of each process.

The press server generates process information 4310 using a device F (PDF input and no-collation output) based on the received intermediate job ticket 4308. On the other hand, the prepress server transmits, to the MIS, information 4309 indicating no presence of a device satisfying the intent information and having PS output capability.

In response to the result, the process analysis section 305 determines whether a workflow is generable. The process analysis section 305 determines that no workflow can be generated because of absence of process information of the postpress process having no-collation input and case binding output.

In response to the determination result, the intermediate JT generating section 302 generates intermediate job ticket 3 (4311) containing no-collation input format as new conditions. However, the postpress server returns information 4312 indicating that the postpress server cannot generate process information capable of realizing the intermediate job ticket 4311.

Hence, the intermediate job ticket generating section 302 generates intermediate job ticket 4 (4313 through 4315) containing modified intent information. For example, the delivery time in the intent information may be changed from “until tomorrow” to “one week later.” As a result, the manager of each processing process can select a device in a wider range. The MIS can receive new process job tickets (4316 through 4319).

The process analysis section 305 determines that a workflow is generable based on the process job tickets (4316 through 4319) newly generated based on the intermediate job ticket 4 and the stored process information (4304 through 4306 and 4310). If the process analysis section 305 determines that plural workflows are generable, the workflow generating section 307 can generate a workflow using the process job tickets held by the MIS. When plural workflows are generable, the workflow generating section 307 can select a lowest-cost workflow or an earliest deliverable workflow.

In this manner, the first exemplary embodiment can automatically generate a workflow in a situation that no information of each processing process is obtainable.

### Second Exemplary Embodiment

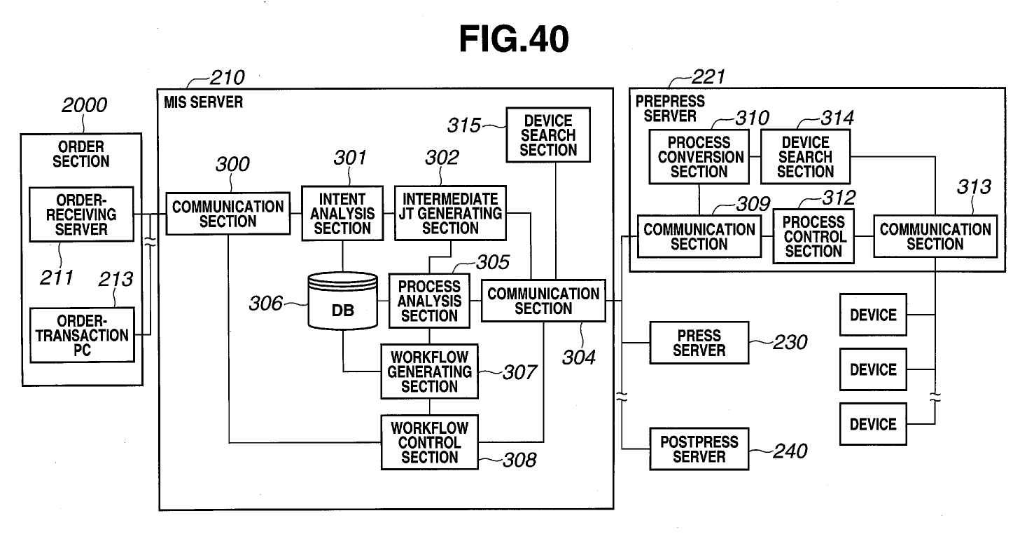

Hereinafter, a second exemplary embodiment of the present invention is described. The second exemplary embodiment is similar to the first exemplary embodiment in fundamental arrangement. Thus, differences between the first and second exemplary embodiments will be described below. FIG. 40 illustrates an exemplary system arrangement according to the second exemplary embodiment, which corresponds to the block diagram of the first exemplary embodiment shown in FIG. 14.

According to the first exemplary embodiment, the database 303 stores the information relating to a manager corresponding to a processing process. The system according to the second exemplary embodiment includes a device search section 315 connected to the communication section 304. The device search section 315 can collect information of each manager connected to the MIS server 210 via the communication section 304. The device search section 315 can determine a manager corresponding to a processing process based on the collected information.

The communication section 304 determines a sending destination of an intermediate job ticket according to the determination by the device search section 315. Furthermore, with respect to the relationship between a process and a device in a manager, a device search section 314 can dynamically obtain device information and can convert the device information into process information.

As described above, by providing the device search section capable of searching a corresponding device or manager, the present embodiment can automatically generate a workflow even if a new manager or device is connected to a system.

### Third Exemplary Embodiment

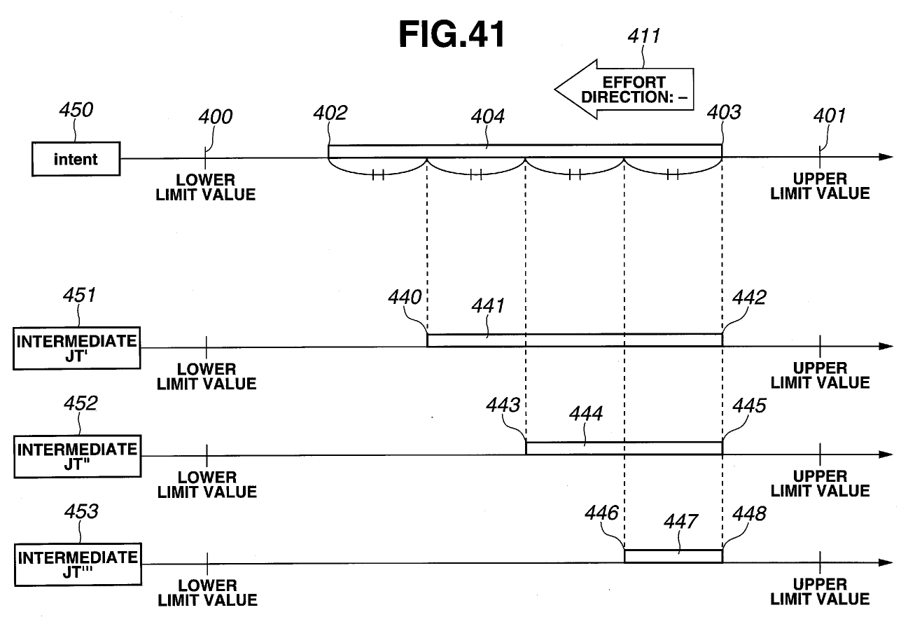

Hereinafter, a third exemplary embodiment of the present invention is described. The third exemplary embodiment is similar to the first exemplary embodiment in fundamental arrangement. Thus, differences between the first and third exemplary embodiments will be described below. FIG. 41 illustrates a method for loosening intent conditions according to the third exemplary embodiment. FIG. 41 shows illustration corresponding to FIG. 32 described in the first exemplary embodiment.

### [Alternative Method for Loosening Intent Conditions]

FIG. 41 includes a minus effort direction value. In FIG. 41, intent information 450 is received from the order section. The third exemplary embodiment determines an intent information loosening method based on the total number of generated intermediate job tickets. FIG. 41 shows three intermediate job tickets. Namely, the total number of generated intermediate job tickets is three. Intermediate job ticket 451 includes modified intent conditions. Intermediate job ticket 452 includes conditions modified from the intermediate job ticket 451. Furthermore, intermediate job ticket 453 includes conditions modified from the intermediate job ticket 452.

In other words, first conversion processing generates the intermediate job ticket 451, second conversion processing generates the intermediate job ticket 452, and third conversion processing generates the intermediate job ticket 453.

As shown in FIG. 41, the intent condition loosening method of the present embodiment includes equally dividing the initial value range 404 by (predetermined number+1) to obtain a division unit range, and updating the lower limit value of the effort direction in increments of the obtained division unit range in response to each generation of the intermediate job ticket. The upper limit values 442, 445, and 448 are unchanged compared to the initial upper limit value 403 of the intent information. On the other hand, if the effort direction value has a plus value, it is preferable to update the upper limit value of the effort direction in the same manner. The intent conditions of the intermediate job ticket 451 are intent conditions 440 to 442 into which intent conditions 402 to 403 are converted. Similarly, the intent conditions of the intermediate job ticket 452 are intent conditions 443 to 445 into which intent conditions 440 to 442 are converted. And, the intent conditions of the intermediate job ticket 453 are intent conditions 446 to 448 into which intent conditions 443 to 445 are converted.

The intent condition loosening method according to the third exemplary embodiment is effectively used when the value range designated in the intent information is finite because the designated search range can be uniformly changed. As described above, if intent information having a finite value range is designated, the present embodiment can search candidate process information in a wider range.

Furthermore, software program code (i.e., program code corresponding to the exemplary flowcharts) for realizing the functions of the above-described exemplary embodiments can be supplied directly or remotely to a system or an apparatus connected to various devices. A computer (or CPU or micro-processing unit (MPU)) in the system or the apparatus can execute the program to operate the devices to realize the functions of the above-described exemplary embodiments. Accordingly, the present invention encompasses the program code installable in a computer when the functions or processes of the exemplary embodiments can be realized by the computer.

In this case, the program code itself can realize the functions of the exemplary embodiments. The equivalents of programs can be used if they possess comparable functions. Furthermore, the present invention encompasses supplying the program code to a computer, such as a storage (or recording) medium storing the program code. In this case, the type of program can be any one of object code, interpreter program, and OS script data. A storage medium supplying the program can be selected from any one of a flexible (floppy) disk, a hard disk, an optical disk, a magneto-optical (MO) disk, a compact disk-ROM (CD-ROM), a CD-recordable (CD-R), a CD-rewritable (CD-RW), a magnetic tape, a nonvolatile memory card, a ROM, and a DVD (DVD-ROM, DVD-R).

The method for supplying the program includes accessing a web site on the Internet using the browsing function of a client computer, when the web site allows each user to download the computer program of the present invention, or compressed files of the programs having automatic installing functions, to a hard disk or other recording medium of the user.

Furthermore, the program code constituting the programs of the present invention can be divided into a plurality of files so that respective files are downloadable from different web sites. Namely, the present invention encompasses WWW servers that allow numerous users to download the program files so that the functions or processes of the present invention can be realized on their computers.

Next, enciphering the programs of the present invention and storing the enciphered programs on a CD-ROM or comparable recording medium is an exemplary method when the programs of the present invention are distributed to the users. The authorized users (i.e., users satisfying predetermined conditions) are allowed to download key information from a page on the Internet. The users can decipher the programs with the obtained key information and can install the programs on their computers. When the computer reads and executes the installed programs, the functions of the above-described exemplary embodiments can be realized.

Moreover, an operating system (OS) or other application software running on the computer can execute part or all of the actual processing based on instructions of the programs.

Additionally, the program code read out of a storage medium can be written into a memory of a function expansion board equipped in a computer or into a memory of a function expansion unit connected to the computer. In this case, based on an instruction of the program, a CPU provided on the function expansion board or the function expansion unit can execute part or all of the processing so that the functions of the above-described exemplary embodiments can be realized.

The present invention can be applied to a system including plural devices or can be applied to a single apparatus.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-091228 filed Mar. 29, 2006, which is hereby incorporated by reference herein in its entirety.

What is claimed:

1. An information processing apparatus capable of communicating with a plurality of processing content determination apparatus that determine processing content of each processing process and generating a workflow defining processing content of a plurality of processing processes, the information processing apparatus comprising:
a reception unit configured to receive setting information required to obtain an output result;
a generation unit configured to generate generating instruction information including input format information input to the workflow or output format information output from the workflow as workflow generation conditions based on setting information received from the reception unit;
a determination unit configured to transmit the generating instruction information generated by the generation unit to the plurality of processing content determination apparatus, receive processing content information including input conditions and output conditions of each processing process returned from the plurality of processing content determination apparatus, and determine whether a workflow can be generated to obtain the output result by combining the received processing content information;
a regeneration unit configured to regenerate, when the determination unit determines that no workflow can be generated, generating instruction information containing new workflow generation conditions newly added to the workflow generation conditions to generate a workflow; and
a workflow generation unit configured to transmit the generating instruction information regenerated by the regeneration unit to a processing content determination apparatus which is a transmission source of processing content information that is identified as a cause of denial by the determination unit, and generate a workflow to obtain the output result based on determination result of re-determination processing using processing content information re-received from the processing content determination apparatus.

2. The information processing apparatus according to claim 1, wherein the determination unit determines whether continuous processing processes are connectable based on input conditions and output conditions contained in each processing content information generated by the plurality of processing content determination apparatus, wherein when the determination unit determines that no workflow can be generated, the regeneration unit transmits generating instruction information including workflow generation conditions that designate changing the input conditions or the output conditions of at least one processing process of the continuous processing processes, to a processing content determination apparatus that determines processing content of the processing process.

3. The information processing apparatus according to claim 1, wherein the determination unit determines whether a workflow can be generated based on information relating to execution of imposition processing contained in processing content information generated by the plurality of processing content determination apparatus.

4. The information processing apparatus according to claim 1, further comprising a process determination unit configured to determine a processing process required to output the output result based on the setting information, wherein a transmission unit transmits the generating instruction information to a processing content determination apparatus that determines processing content of the processing process determined by the process determination unit.

5. The information processing apparatus according to claim 4, further comprising a storage unit configured to store information associating the setting information with processing process, wherein the process determination unit determines the required processing process based on the setting information received by the reception unit and the information stored in the storage unit.

6. The information processing apparatus according to claim 1, wherein when the determination unit determines that no workflow can be generated, the regeneration unit transmits the generating instruction information to one of processing content determination apparatus executing the continuous processing processes.

7. The information processing apparatus according to claim 1, wherein the determination unit re-determines whether a workflow can be generated based on processing content information generated by the processing content determination apparatus according to the generating instruction information regenerated by the regeneration unit.

8. The information processing apparatus according to claim 1, further comprising a transmission unit configured to transmit, when the determination unit determines that a workflow can be generated, an instruction generated based on at least one of processing content information generated by the plurality of processing content determination apparatus, to the processing content determination apparatus.

9. A method for an information processing apparatus capable of communicating with a plurality of processing content determination apparatus that determine processing content of each processing process and generating a workflow defining processing content of a plurality of processing processes, the method comprising:
receiving setting information required to obtain an output result;
generating generating instruction information including input format information input to the workflow or output format information output from the workflow as workflow generation conditions based on the received setting information;
transmitting the generated generating instruction information to the plurality of processing content determination apparatus, receiving processing content information including input conditions and output conditions of each processing process returned from the plurality of processing content determination apparatus, and determining whether a workflow can be generated to obtain the output result by combining the received processing content information;
regenerating, when no workflow can be generated, generating instruction information containing new workflow generation conditions newly added to the workflow generation conditions to generate a workflow; and
transmitting the regenerated generating instruction information to a processing content determination apparatus which is a transmission source of processing content information that is identified as a cause of denial in the determination, and generating a workflow to obtain the output result based on determination result of re-determination processing using processing content information re-received from the processing content determination apparatus.

10. The method according to claim 9, further comprising:
determining whether continuous processing processes are connectable based on input conditions and output conditions contained in each processing content information generated by the plurality of processing content determination apparatus; and
transmitting, when no workflow can be generated, generating instruction information including workflow generation conditions that designate changing the input conditions or the output conditions of at least one processing process of the continuous processing processes to a processing content determination apparatus that determines processing content of the processing process.

11. The method according to claim 9, further comprising determining whether a workflow can be generated based on information relating to execution of imposition processing contained in processing content information generated by the plurality of processing content determination apparatus.

12. The method according to claim 9, further comprising:
determining a processing process required to output the output result based on the setting information; and
transmitting the generating instruction information to a processing content determination apparatus that determines processing content of the determined processing process.

13. The method according to claim 12, further comprising:
storing information associating the setting information with processing process; and
determining the required processing process based on the received setting information and the stored information.

14. The method according to claim 9, further comprising transmitting, when no workflow can be generated, the regenerated generating instruction information to one of processing content determination apparatus executing the continuous processing processes.

15. The method according to claim 9, further comprising re-determining whether a workflow can be generated based on the processing content information generated according to the regenerated generating instruction information.

16. The method according to claim 9, further comprising transmitting, when the workflow can be generated, an instruction generated based on at least one of processing content information generated by the plurality of processing content determination apparatus, to the processing content determination apparatus.

17. A computer readable medium containing computer-executable instructions for controlling an information processing apparatus capable of communicating with a plurality of processing content determination apparatus that determine processing content of each processing process and generating a workflow defining processing content of a plurality of processing processes, the medium comprising:
computer-executable instructions for receiving setting information required to obtain an output result;
computer-executable instructions for generating generating instruction information including input format information input to the workflow or output format information output from the workflow as workflow generation conditions based on the received setting information;
computer-executable instructions for transmitting the generated generating instruction information to the plurality of processing content determination apparatus, receiving processing content information including input conditions and output conditions of each processing process returned from the plurality of processing content determination apparatus, and determining whether a workflow can be generated to obtain the output result by combining the received processing content information;
computer-executable instructions for regenerating, when no workflow can be generated, generating instruction information containing new workflow generation conditions newly added to the workflow generation conditions to generate a workflow; and
computer-executable instructions for transmitting the regenerated generating instruction information to a processing content determination apparatus which is a transmission source of processing content information that is identified as a cause of denial in the determination, and generating a workflow to obtain the output result based on determination result of re-determination processing using processing content information re-received from the processing content determination apparatus.

18. The medium according to claim 17, further comprising:
computer-executable instructions for determining whether continuous processing processes are connectable based on input conditions and output conditions contained in each processing content information generated by the plurality of processing content determination apparatus; and
computer-executable instructions for transmitting, when no workflow can be generated, generating instruction information including workflow generation conditions that designate changing the input conditions or the output conditions of at least one processing process of the continuous processing processes, to a processing content determination apparatus that determines processing content of the processing process.

19. The medium according to claim 17, further comprising computer-executable instructions for determining whether a workflow can be generated based on information relating to execution of imposition processing contained in processing content information generated by the plurality of processing content determination apparatus.

20. The medium according to claim 17, further comprising:
computer-executable instructions for determining a processing process required to output the output result based on the setting information; and
computer-executable instructions for transmitting the generating instruction information to a processing content determination apparatus that determines processing content of the determined processing process.

21. The medium according to claim 20, further comprising:
computer-executable instructions for storing information associating the setting information with processing process; and
computer-executable instructions for determining the required processing process based on the received setting information and the stored information.

22. The medium according to claim 17, further comprising computer-executable instructions for transmitting, when no workflow can be generated, the regenerated generating instruction information to one of processing content determination apparatus executing the continuous processing processes.

23. The medium according to claim 17, further comprising computer-executable instructions for re-determining whether the workflow can be generated based on the processing content information generated according to the regenerated generating instruction information.

24. The medium according to claim 17, further comprising computer-executable instructions for transmitting, when the workflow can be generated, an instruction generated based on at least one of processing content information generated by the plurality of processing content determination apparatus, to the processing content determination apparatus.
